(19) United States
(12) Patent Application Publication
(10) Pub. No.: US 2016/0077329 A1
(43) Pub. Date: Mar. 17, 2016

(54) DITHERED DISPLAYS AND DITHERING PROCESSES AND APPARATUS

(71) Applicant: Pixtronix, Inc., San Diego, CA (US)

(72) Inventors: Katsumi Matsumoto, Yonago (JP); Tsutomu Kobayashi, Tokyo (JP); Edward Buckley, Melrose, MA (US); Xiang-Dong Mi, Acton, MA (US); Jianru Shi, Haverhill, MA (US); Jignesh Gandhi, Burlington, MA (US); Timothy Brosnihan, Natick, MA (US)

(21) Appl. No.: 14/719,158

(22) Filed: May 21, 2015

Related U.S. Application Data
(60) Provisional application No. 62/049,246, filed on Sep. 11, 2014.

(51) Int. Cl. G02B 26/02; G09G 3/20; G09G 5/02

(52) U.S. Cl. CPC G02B 26/02; G09G 5/02; G09G 3/2051

(57) ABSTRACT

In one innovative aspect of the disclosure, a method includes patterning a first region and a first portion of a second region of a substrate using a first reticle. The method also includes patterning the second region and a first portion of the first region using a second reticle. The method additionally includes forming a first array of first patterned elements based on the patterning by the first reticle, and forming a second array of second patterned elements based on the patterning by the second reticle. In some implementations, each of the first and the second arrays are incomplete in each of the first portions. However, the first patterned elements in the first portion of the second region are complementary to the second patterned elements in the first portion of the second region. Similarly, the first patterned elements in the first portion of the first region are complementary to the second patterned elements in the first portion of the first region. In some such implementations, the combination of the first array and the second array form a complete array of patterned elements.

### PRIORITY DATA

This application claims the benefit of priority under 35 U.S.C. §119(e) to U.S. Provisional Application No. 62/049,246 (Attorney Docket No. QUALP283P/147091P1) by Matsumoto et al., titled DITHERING FOR DISPLAYS and filed on 11 Sep. 2014, which is hereby incorporated by reference in its entirety for all purposes.

### TECHNICAL FIELD

This disclosure relates to generally to displays, and more particularly, to using one or more dithering operations to improve the image quality of a display.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

Some MEMS-based display devices include a plurality of MEMS-based display elements formed on a substrate and arranged in an array. Each of the MEMS-based display elements can modulate the passage of light through the display element. In some such display devices, the modulated light that passes through the display elements travels toward an array of corresponding apertures. The light that passes through the apertures forms an image. In some instances, the quality of the displayed image depends upon the alignment between the MEMS-based display elements and the corresponding apertures. For example, misalignment between the MEMS-based display elements and the corresponding apertures can negatively impact the quality of the displayed image by introducing static image artifacts.

### SUMMARY

In one innovative aspect of the disclosure, a device is described that includes a substrate including a first region and a second region, a boundary of the first region proximate a boundary of the second region. The device includes a first layer over the substrate. The first layer is patterned in the first region and in a first portion of the second region with a first array of first patterned elements. The first layer is further patterned in the second region and in a first portion of the first region with a second array of second patterned elements. Each of the first and the second arrays are incomplete in each of the first portions. However, the first array of first patterned elements in the first portion of the second region is complementary to the second array of second patterned elements in the first portion of the second region. Similarly, the first array of first patterned elements in the first portion of the first region is complementary to the second array of second patterned elements in the first portion of the first region. The combination of the first array of first patterned elements and the second array of second patterned elements in the first portions of the first and the second regions form a complete array of patterned elements.

In some implementations, the first array of first patterned elements includes cells of a first pattern type and a second pattern type. The second array of second patterned elements also can include cells of a first pattern type and a second pattern type. The first array cells of the first pattern type are complementary to the second array cells of the first pattern type, and the first array cells of the second pattern type are complementary to the second array cells of the second pattern type. In some such implementations, the first array cells of the first pattern type include no patterned elements, while the first array cells of the second pattern type include complete patterned elements. In such implementations, the second array cells of the first pattern type can include complete patterned elements, while the second array cells of the second pattern type include no patterned elements.

In some other implementations, each first array cell of the first pattern type includes a first portion of the patterned elements, and each first array cell of the second pattern type includes a second portion of the patterned elements. Similarly, each second array cell of the first pattern type includes the second portion of the patterned elements, and each second array cell of the second pattern type includes the first portion of the patterned elements.

In some implementations, the first array of first patterned elements further includes cells of a third pattern type and cells of a fourth pattern type. The second array of second patterned elements also can include cells of a third pattern type and cells of a fourth pattern type. The first array cells of the third pattern type are complementary to the second array cells of the third pattern type, and the first array cells of the fourth pattern type are complementary to the second array cells of the fourth pattern type. In some implementations, each first array cell of the third pattern type includes a third portion of the patterned elements, and each first array cell of the fourth pattern type includes a fourth portion of the patterned elements. Similarly, each second array cell of the third pattern type includes the fourth portion of the patterned elements, and each second array cell of the fourth pattern type includes the third portion of the patterned elements.

In some implementations, the device further includes a second layer over the substrate. The second layer can be patterned in the first region and in the first portion of the second region with a third array of third patterned elements. The second layer can further be patterned in the second region and in the first portion of the first region with a fourth array of fourth patterned elements. Similar to the first and the second arrays of the first layer, each of the third and the fourth arrays can be incomplete in the first portions of the first and the second regions. However, the third array of third patterned elements in the first portion of the second region is complementary to the fourth array of fourth patterned elements in the first portion of the second region, and the third array of third patterned elements in the first portion of the first region is complementary to the fourth array of fourth patterned elements in the first portion of the first region. The combination of the third array of third patterned elements and the fourth array of fourth patterned elements in the first portions of the first and the second regions forms a complete second array of patterned elements.

In some implementations, the device further includes a second substrate including a third region and a fourth region, a boundary of the third region proximate a boundary of the fourth region. The device includes a second layer over the second substrate, the second layer being patterned in the third region and in a first portion of the fourth region with a third array of third patterned elements. The second layer is further patterned in the fourth region and in a first portion of the third region with a fourth array of fourth patterned elements. Each of the third and the fourth arrays are incomplete in the first portions of the third and the fourth regions. However, the third array of third patterned elements in the first portion of the fourth region is complementary to the fourth array of fourth patterned elements in the first portion of the fourth region, and the third array of third patterned elements in the first portion of the third region is complementary to the fourth array of fourth patterned elements in the first portion of the third region. The combination of the third array of third patterned elements and the fourth array of fourth patterned elements in the first portions of the third and the fourth regions forms a complete array of patterned elements.

In some implementations, the substrate is a panel of a display that includes an array of display elements. The combination of the first array of first patterned elements and the second array of second patterned elements can form at least portions of the display elements. In some implementations, the device further includes a processor capable of processing image data, and a memory device capable of communicating with the processor. The device can further include a driver circuit capable of sending at least one signal to the display elements, and a controller capable of sending at least a portion of the image data to the driver circuit. The device can further include an image source module capable of sending the image data to the processor, the image source module including at least one of a receiver, transceiver, and transmitter. The device can further include an input device capable of receiving input data and communicating the input data to the processor.

In another innovative aspect of the disclosure, a method is described that includes patterning a first region and a first portion of a second region of a substrate using a first reticle, a boundary of the first region proximate a boundary of the second region. The method also includes patterning the second region and a first portion of the first region of the substrate using a second reticle. The method additionally includes forming a first array of first patterned elements based on the patterning by the first reticle. The method further includes forming a second array of second patterned elements based on the patterning by the second reticle. Each of the first and the second arrays is incomplete in each of the first portions. However, the first array of first patterned elements in the first portion of the second region is complementary to the second array of second patterned elements in the first portion of the second region. Similarly, the first array of first patterned elements in the first portion of the first region is complementary to the second array of second patterned elements in the first portion of the first region. The combination of the first array of first patterned elements and the second array of second patterned elements in the first portions of the first and the second regions form a complete array of patterned elements.

In some implementations, the substrate is a panel of a display that includes an array of display elements. The combination of the first array of first patterned elements and the second array of second patterned elements can form at least portions of the display elements.

In some implementations, the first array of first patterned elements includes cells of a first pattern type and a second pattern type. The second array of second patterned elements also includes cells of a first pattern type and a second pattern type. The first array cells of the first pattern type are complementary to the second array cells of the first pattern type. Similarly, the first array cells of the second pattern type are complementary to the second array cells of the second pattern type. In some such implementations, the first array cells of the first pattern type include no patterned elements, while the first array cells of the second pattern type include complete patterned elements. In such implementations, the second array cells of the first pattern type can include complete patterned elements, while the second array cells of the second pattern type include no patterned elements.

In some other implementations, each first array cell of the first pattern type includes a first portion of the patterned elements, while each first array cell of the second pattern type includes a second portion of the patterned elements. Similarly, each second array cell of the first pattern type can include the second portion of the patterned elements, while each second array cell of the second pattern type includes the first portion of the patterned elements.

In some implementations, the first array of first patterned elements further includes cells of a third pattern type and cells of a fourth pattern type. Similarly, the second array of second patterned elements further includes cells of a third pattern type and cells of a fourth pattern type. The first array cells of the third pattern type are complementary to the second array cells of the third pattern type, and the first array cells of the fourth pattern type are complementary to the second array cells of the fourth pattern type. In some such implementations, each first array cell of the third pattern type includes a third portion of the patterned elements, while each first array cell of the fourth pattern type includes a fourth portion of the patterned elements. Similarly, each second array cell of the third pattern type includes the fourth portion of the patterned elements, while each second array cell of the fourth pattern type includes the third portion of the patterned elements.

In some implementations, the method further includes patterning the first region and the first portion of the second region of the substrate using a third reticle. The method also includes patterning the second region and the first portion of the first region of the substrate using a fourth reticle. The method additionally includes forming a third array of third patterned elements based on the patterning by the third reticle. The method further includes forming a fourth array of fourth patterned elements based on the patterning by the fourth reticle. Each of the third and the fourth arrays are incomplete in the first portions of the first and the second regions. However, the third array of third patterned elements in the first portion of the second region is complementary to the fourth array of fourth patterned elements in the first portion of the second region. Similarly, the third array of third patterned elements in the first portion of the first region is complementary to the fourth array of fourth patterned elements in the first portion of the first region. The combination of the third array of third patterned elements and the fourth array of fourth patterned elements in the first portions of the first and the second regions forms a complete array of patterned elements.

In some implementations, the method further includes patterning a third region and a first portion of a fourth region of a second substrate using a third reticle, a boundary of the third region proximate a boundary of the fourth region. The method also includes patterning the fourth region and a first portion of the third region of the second substrate using a fourth reticle. The method additionally includes forming a third array of third patterned elements based on the patterning by the third reticle. The method further includes forming a fourth array of fourth patterned elements based on the patterning by the fourth reticle. Each of the third and the fourth arrays is incomplete in the first portions of the third and the fourth regions. However, the third array of third patterned elements in the first portion of the fourth region is complementary to the fourth array of fourth patterned elements in the first portion of the fourth region. Similarly, the third array of third patterned elements in the first portion of the third region is complementary to the fourth array of fourth patterned elements in the first portion of the third region. The combination of the third array of third patterned elements and the fourth array of fourth patterned elements in the first portions of the third and the fourth regions forms a complete array of patterned elements.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 is a perspective view of an example dual actuator shutter assembly according to some implementations.

FIG. 4A shows a cross-section of a multi-pane display panel including four MEMS-based display elements according to some implementations.

FIGS. 4B-4D show cross-sections of other arrangements of the display panel of FIG. 4A according to some implementations.

FIG. 5 shows an example representation of a stepper processing machine for patterning a substrate according to some implementations.

FIG. 6A shows a portion of an example dark layer having rectangular apertures superimposed over a portion of an example MEMS layer including shutters having slot-shaped apertures according to some implementations.

FIG. 6B shows the arrangement of FIG. 6A, but in FIG. 6B the example dark layer and the example shutters of the MEMS layer are shown in black.

FIG. 6C shows an example MEMS layer including shutters having slot-shaped apertures superimposed over an example aperture layer having slot-shaped apertures according to some implementations.

FIG. 6D shows the arrangement of FIG. 6C, but in FIG. 6D the example aperture layer and the example shutters and actuators of the MEMS layer are shown in black.

FIG. 7A shows an example display device including a display panel that includes two regions.

FIG. 7B shows an example display device 707 including a display panel 708 that includes two regions 708a and 708b according to some implementations.

FIG. 8 shows the display panel of FIG. 7B along with separated views of representations of first and second reticles used to pattern each of the regions.

FIG. 9 shows a representation of an example dithering element according to some implementations.

FIG. 10 shows a representation of a dithering element for patterning a dithered region using a first reticle, a complementary dithering element for patterning the dithered region using a second reticle, and the resulting dithered region after patterning by both of the dithering elements according to some implementations.

FIG. 11 shows how dithering can be used to form a dithered portion of a first metal layer of a multi-layered MEMS layer according to some implementations.

FIG. 12 shows another example of a right reticle for patterning and forming a first metal layer of a MEMS layer on a right region according to some implementations.

FIG. 13 shows another example of a left reticle for patterning and forming a first metal layer of a MEMS layer on a left region according to some implementations.

FIG. 14 shows how dithering can be used to form a dithered portion of a second metal layer of a multi-layered MEMS layer according to some implementations.

FIG. 15 shows how dithering can be used to form a dithered portion of an aperture layer according to some implementations.

FIG. 16A shows a portion of an example display panel that includes three regions according to some implementations.

FIG. 16B shows a portion of an example display panel that includes four regions according to some implementations.

FIG. 17 shows a flowchart illustrating an example process for forming a dithered region on a substrate.

FIGS. 18A and 18B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. Some of the concepts and examples provided in this disclosure are especially applicable to electromechanical systems (EMS) and microelectromechanical (MEMS)-based displays such as the shutter-based displays described herein. However, some implementations also may be applicable to other types of displays, such as liquid crystal displays (LCDs), organic light-emitting diode (OLED) displays, and field emission displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various implementations relate generally to dithering processes and related apparatus for introducing dither in the formation of display elements, and in some more specific implementations, the display elements proximate region boundary lines. Various implementations also relate to display panels and constituent display elements formed using such dithering processes. Dither can be broadly defined as an intentional application of noise or the result of the application of such noise. In some implementations, the noise can be applied according to specifically designed patterns rather than randomly. In some implementations, dither is introduced using specially designed reticles, for example, during the patterning of various layers that form the display elements.

Particular implementations of the subject matter described in this disclosure can be implemented to realize one or more of the following potential advantages. The dithering processes described herein can broadly serve to mitigate the appearance of boundary lines between adjacent regions of a display panel. In some implementations, various dithering processes described herein also can serve to reduce the appearance of disparities in the luminosities of different regions of the display panel.

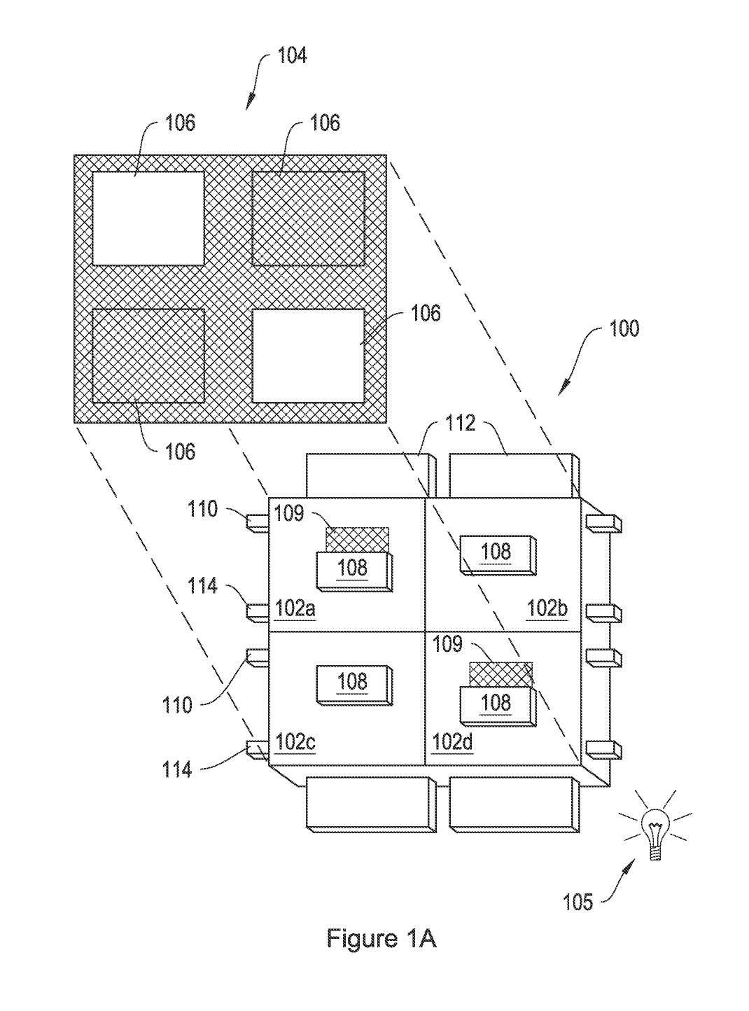

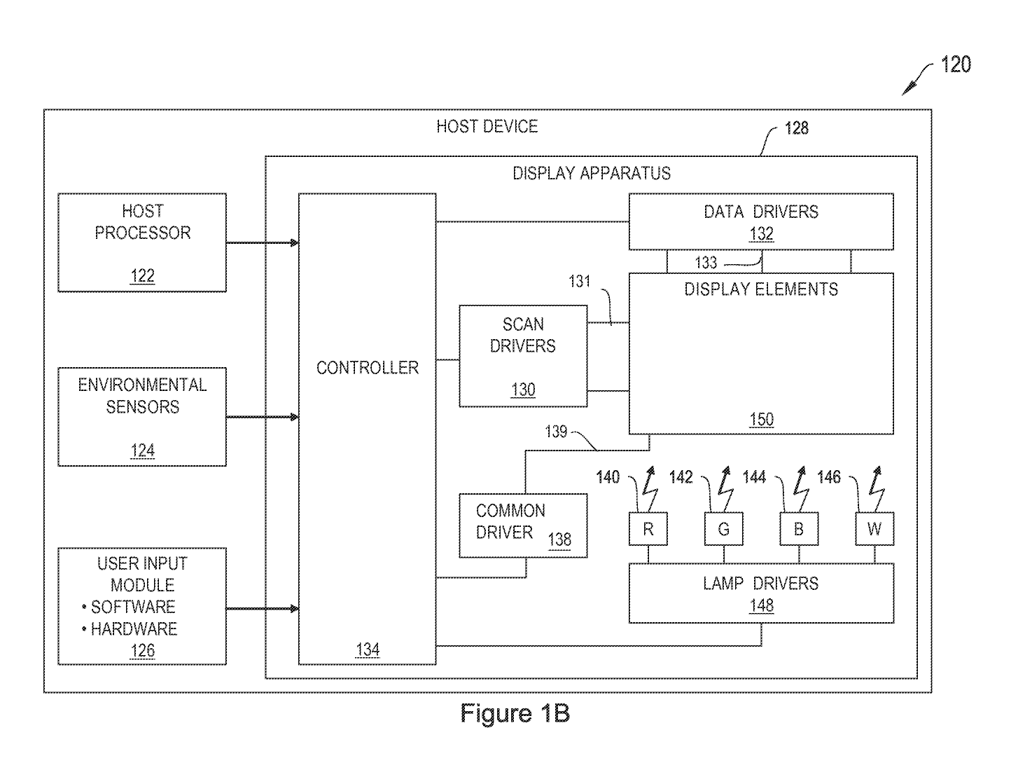

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104, for example, when illuminated by a backlight including one or more lamps or LED arrays 105. In another implementation, the apparatus 100 may form an image by reflection of ambient light originating from the front of the apparatus. In another implementation, the apparatus 100 may form an image by reflection of light from a lamp or lamps positioned in the front of the display, for example, by use of a front light.

In some implementations, each light modulator 102 corresponds to a pixel 106 in the image 104. In some other implementations, the display apparatus 100 may utilize a plurality of light modulators 102 to form a pixel 106 in the image 104. For example, the display apparatus 100 may include three color-specific light modulators 102 for each pixel 106. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a desired luminance level in an image 104. With respect to an image, a pixel corresponds to the smallest picture element defined by the resolution of the image. With respect to structural components of the display apparatus 100, the term pixel refers to the combination of mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing the brightness or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a layer assembly arrangement where one substrate containing the light modulators is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 includes at least one shutter 108 and at least one aperture 109. To illuminate a pixel 106 in the image 104, the shutter 108 is positioned such that it allows light to pass through the aperture 109. To maintain or transition a pixel 106 to an unlit (or dark or black) state, the shutter 108 is positioned such that it obstructs the passage of light through the aperture 109. The aperture 109 is defined by an opening patterned through a reflective or light-absorbing material in each light modulator 102.

The display apparatus 100 also includes a control matrix coupled to the substrate and to the light modulators 102 for controlling the movement of the shutters 108. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. In some implementations, the data voltage pulses applied to the data interconnects 112 directly contribute to an electrostatic movement of the shutters 108. In some other implementations, the data voltage pulses control switches, such as transistors or other non-linear circuit elements, which control the application of separate drive voltages to the light modulators 102. Such separate drive voltages can advantageously be higher or greater in magnitude than the data voltages. In such implementations, the application of the drive voltages results in the electrostatic-driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state (also referred to herein as a “configuration”), a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states (configurations), the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

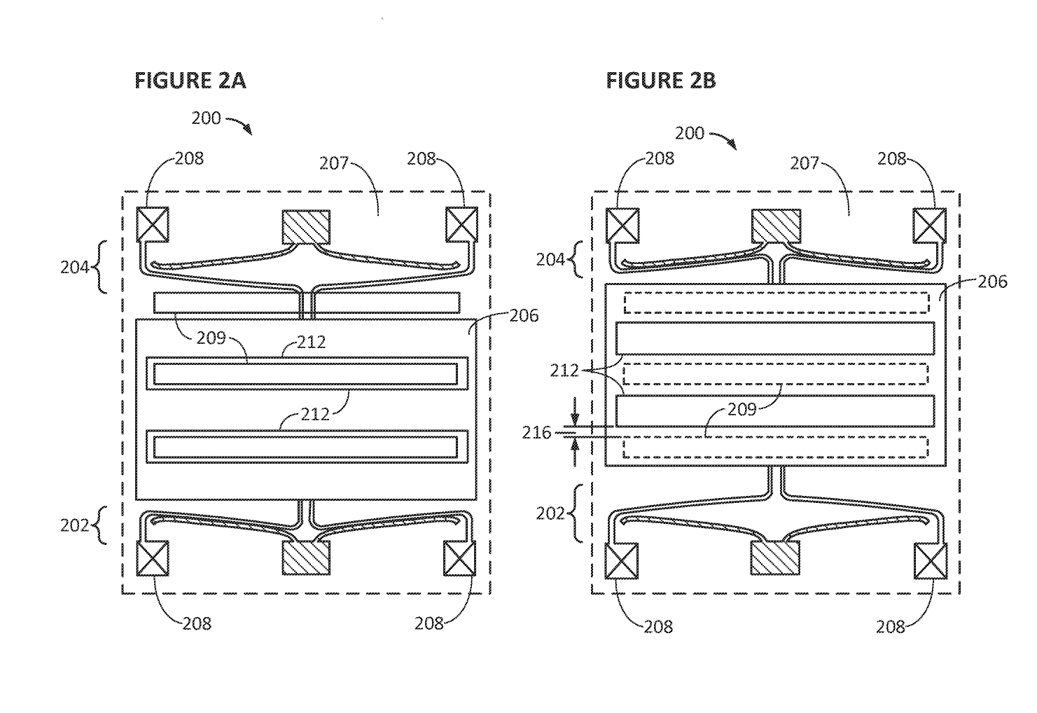

FIGS. 2A and 2B show views of an example dual actuator shutter assembly 200. The dual actuator shutter assembly 200, as depicted in FIG. 2A, is in an open state (configuration). FIG. 2B shows the dual actuator shutter assembly 200 in a closed state (configuration). The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single continuous edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 when in the open state, the width or size of the shutter apertures 212 can be designed to be larger than a corresponding width or size of the apertures 209 in the aperture layer 207. In order to effectively block light from escaping the shutter assembly 200 when in the closed state, the light blocking portions of the shutter 206 can be designed to overlap the edges of the apertures 209. FIG. 2B shows an overlap 216, which in some implementations can be predefined, between the edge of the light blocking portions in the shutter 206 and an edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

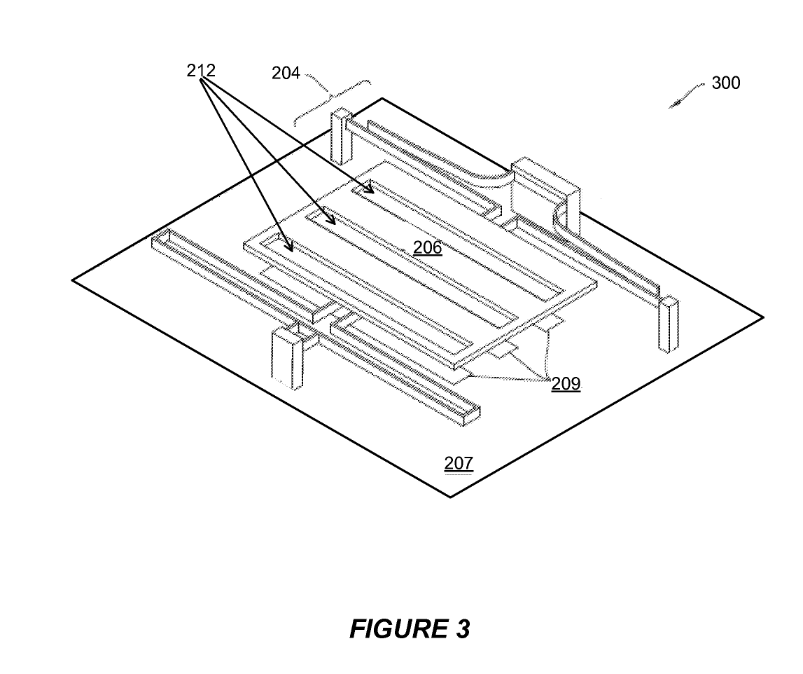

FIG. 3 is a perspective view of an example dual actuator shutter assembly 300. The shutter assembly 300 is similar to the shutter assembly 200 shown in FIGS. 2A and 2B, but includes at least the difference that the shutter 206 in the shutter assembly 300 includes three shutter apertures 212 through which light can pass.

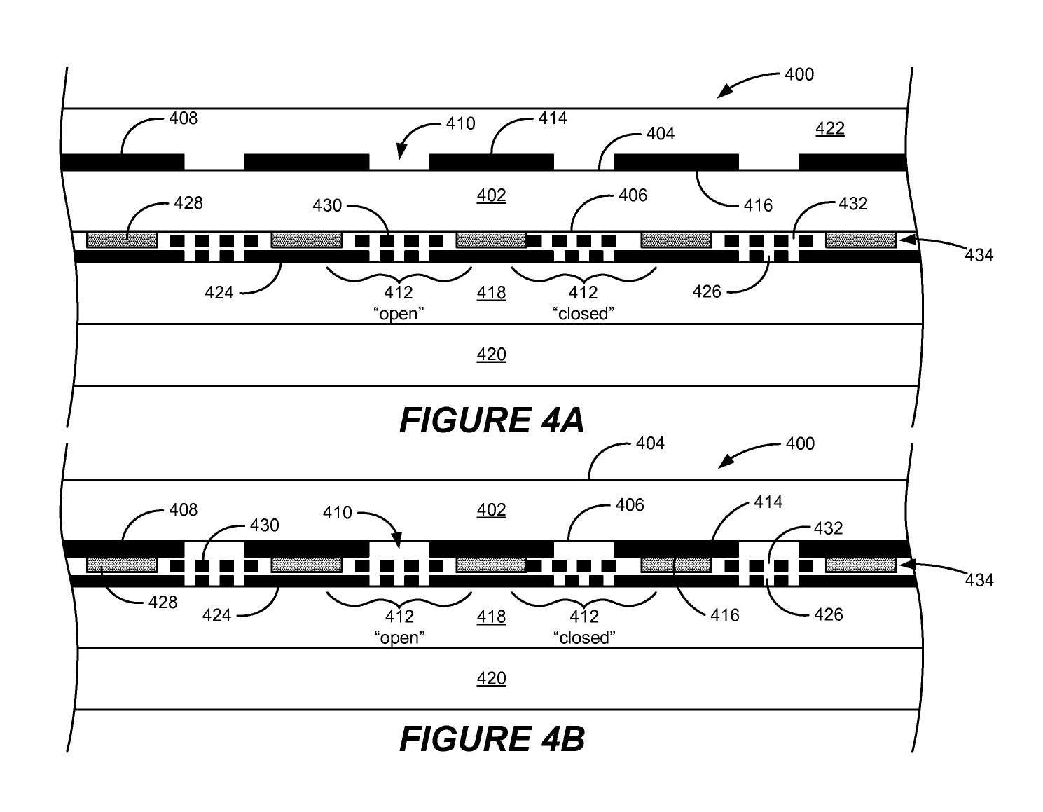

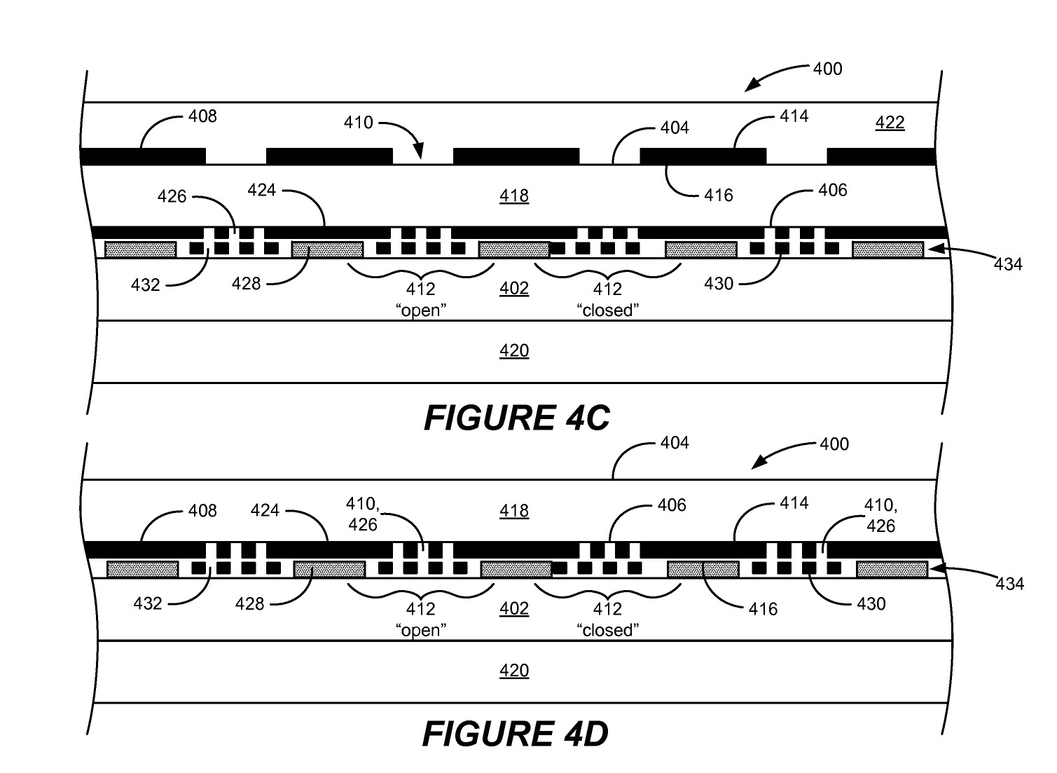

FIG. 4A shows a cross-section of a multi-pane display panel 400 including four MEMS-based display elements 412 according to some implementations. Each of the display elements 412 includes a shutter-based assembly, such as the shutter assemblies 200 or 300 of FIGS. 2A, 2B, and 3. The display panel 400 includes a first transparent panel (also referred to herein as the “backpane”) 402 having a first surface 404 and a second surface 406 opposite the first surface. An opaque layer (also referred to herein as the “dark layer”) 408 is formed over the first surface 404. For example, the dark layer 408 can be formed of a dark or black material such as carbon (C) (or a carbon-based material). In some implementations, the dark layer 408 is spun on to the backpane 402 thereby forming a spin-on-glass (SOG) material layer.

The dark layer 408 includes a multiplicity (a large number) of apertures 410. Each aperture 410 is associated with a respective display element 412 and allows light from the respective display element to pass. For example, the apertures 410 can be slots having high aspect ratios, other rectangular shapes, or other desirable or suitable shapes. In some implementations, all or substantially all of the viewable area of the first surface 404 of the backpane 402 is covered by the dark layer 408 except for those portions where there is an aperture 410. In some implementations, the ratio of the surface area of the first surface 404 where there are apertures 410 to the surface area of the first surface covered by the dark layer 408 (also referred to herein as the “aperture ratio”) is less than approximately 30%, and in some such implementations less than approximately 20%, and in some such implementations less than approximately 10%. In some implementations, the viewable surface 414 (facing the viewer) of the dark layer 408 is a black light-absorbing surface while the inner surface 416 (facing the display elements) of the dark layer is a light-reflecting surface to facilitate light recycling. As such, in some implementations, the dark layer 408 can be a multilayer film.

In some implementations, the backpane 402 is arranged over a second transparent panel (also referred to herein as the “aperture panel”) 418, which is itself arranged over a backlight panel (also referred to herein simply as the “backlight”) 420. In some implementations, a third transparent panel (a “protective panel”) 422 is arranged over the dark layer 408 and the backpane 402. For example, one or more of the backpane 402, the aperture panel 418, the protective panel 422 and the backlight 420 can be formed of a glass material, crystal material, semiconductor material or plastic material.

In some implementations, a second aperture layer 424 is arranged over the aperture panel 418 between the aperture panel 418 and the backpane 402. The second aperture layer 424 includes a multiplicity of apertures 426 (for example, similar to the apertures 209 in the aperture layer 207 of FIGS. 2 and 3). For example, the apertures 426 can be slots having high aspect ratios, other rectangular shapes, or other desirable or suitable shapes. In the illustrated example implementation, each display element 412 includes three slot-shaped apertures 426. In some implementations, the overlying apertures 410 can be square or rectangular shaped. For example, in one implementation, each aperture 410 is large enough to overlie three respective apertures 426. In some other implementations, the apertures 410 in the dark layer 408 also can be slot-shaped. For example, the dark layer 408 can include as many apertures 410 as there are apertures 426 such that each aperture 410 is positioned adjacent (or overlying) a corresponding one of the apertures 426. In some such implementations, the apertures 410 can have aspect ratios the same as or similar to the aspect ratios of the apertures 426 (in some such implementations, the apertures 410 can be slightly larger than the apertures 426 to allow for more light of steeper angles to pass through).

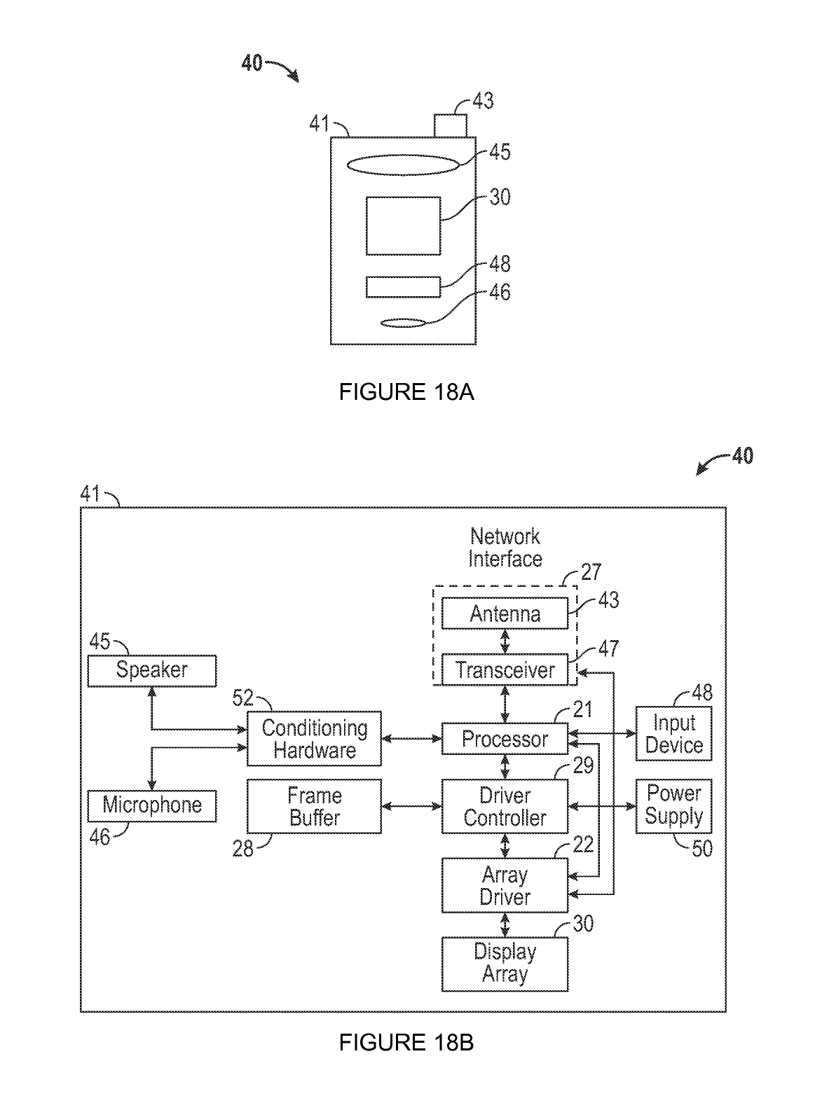

Each display element 412 further includes or is associated with one or more actuators 428 (for example, the actuators 202 and 204 of FIGS. 2 and 3) formed over or adjacent the second surface 406 of the backpane 402. In some implementations, each display element 412 includes a translatable shutter 430 (for example, the shutter 206 of FIGS. 2 and 3). The shutters 430 and the actuators 428 (and wiring or other electrical interconnects associated with the shutters 430 and the actuators 428) are also referred to herein collectively as the MEMS layer (or layers) 434. The actuators 428 cause (for example, via electrostatic actuation) the shutter 430 to move from a closed position to an open position and vice versa responsive to one or more signals from a display driver (for example, the array driver 22 of FIG. 18B). While a shutter 430 is in the closed position, the light-blocking portions of the shutter 430 block or reflect light emitted through the corresponding apertures 426 in the second aperture layer 424. While a shutter 430 is in the open position, the light-passing portions (or apertures) 432 of the shutter 430 (for example, similar to the apertures 212 of FIGS. 2 and 3) permit light emitted through the corresponding apertures 426 to pass through. In some implementations, the shutter apertures 432 are slot-shaped having aspect ratios the same as or similar to the aspect ratios of the corresponding apertures 426 (in some such implementations, the apertures 432 can be slightly larger than the apertures 426 to allow for more light of steeper angles to pass through, for example, as shown by the apertures 212 and 209, respectively, in FIGS. 2A and 2B).

In some other implementations, the dark layer 408 is formed on other surfaces or positioned in different arrangements than in FIG. 4A. FIG. 4B shows a cross-section of a display panel 400 in which the dark layer 408 is positioned between the second surface 406 of the backpane 402 and the MEMS layer 434. FIGS. 4C and 4D show cross-sections of display panels 400 in which a backpane 402 is arranged under an aperture panel 418 (opposite from the arrangements shown in FIGS. 4A and 4B). Additionally, in FIG. 4D, the aperture layer 424 itself serves as the dark layer 408. Alternatively, the aperture layer 424 and the dark layer 408 in FIG. 4D can be formed as a stacked multilayer film. Like reference numerals refer to like elements in the FIGS. 4A-4D.

In some implementations, the MEMS layer 434 including the shutters 430 and the actuators 428 (and wiring or other electrical interconnects) are formed via one or more metallization processes. For example, the shutters 430 and the actuators 428 can be formed using one or more metallization (or metal depositing or growing) processes. The aperture layer 424 also can be formed by using one or more metallization or other layer deposition processes including semiconductor manufacturing processes. The dark layer 408 also can be formed, for example, using one or more layer deposition processes including semiconductor manufacturing processes.

As described above, the display elements 412 can be arranged in one or more arrays of rows and columns to form an entire display. In some implementations, the backpane 402 or the aperture panel 418 are too large (for example, in length or width) to form one or more of the aperture layer 424, the MEMS layer 434, and the dark layer 408 each in a single step. More specifically, in some such implementations, it is necessary or desirable that the formation of the aperture layer 424, the MEMS layer 434, and the dark layer 408 take place in two or more steps (that is, for example, two or more steps for forming the aperture layer 424, two or more steps for forming the MEMS layer 434, and two or more steps for forming the dark layer 408). In some implementations, one or more of the aperture layer 424, the MEMS layer 434, and the dark layer 408 are formed using a stepper processing machine. One example of such a stepper processing machine is the NanoTech 100 stepper processing machine manufactured and sold by UltraTech Inc. of San Jose, Calif. A stepper processing machine uses a light source that can affect properties of certain materials on or in the surface of the substrate as well as chemical processes to create a patterned layer on a substrate.

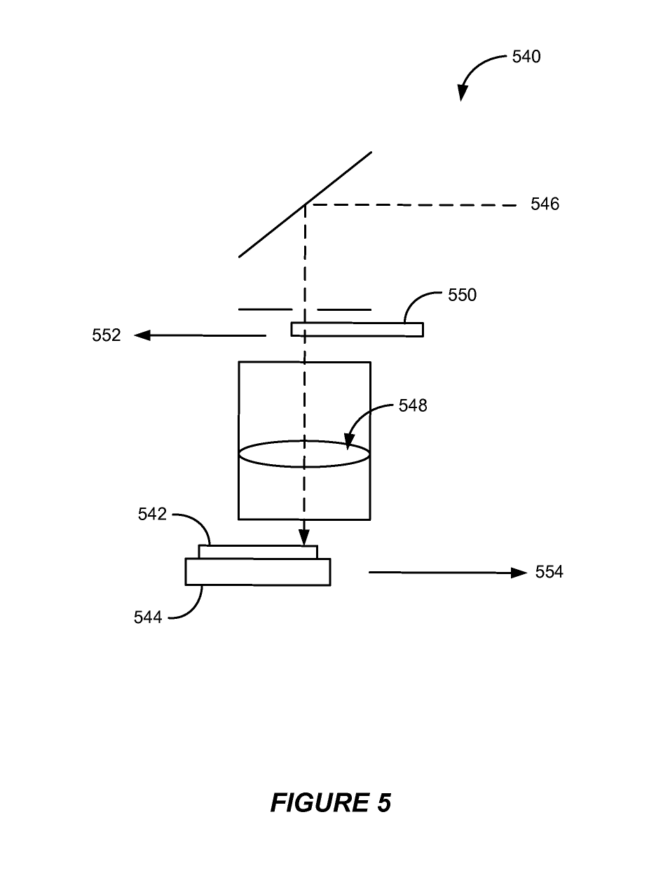

FIG. 5 shows an example representation of a stepper processing machine 540 for patterning a substrate 542 according to some implementations. For example, the substrate 542 can be the backpane 402 or the aperture panel 418 of FIGS. 4A-4D depending on which of the aperture layer 424, the MEMS layer 434, and the dark layer 408 is being patterned (or “formed”) and on the desired arrangement implementation. The substrate 542 is positioned on a movable stage 544. Light from a light source 546 passes through open portions of a reticle 550 and is focused by optics 548 onto the substrate 542. The reticle 550 is similar to a patterned mask; for example, the pattern (the shape and arrangement of the apertures) of the respective layer corresponds to the patterning of the reticle 550. In some implementations, the reticle moves in a direction 552 opposite to the direction 554 of movement of the substrate 542 on the stage 544. For the first region of the substrate 542 to be patterned, the stepper processing machine 540 moves a first region of the substrate 542 underneath the light source 546 and reticle 550. The first region of the substrate 542 moved under reticle 550 may correspond to the first half of the respective layer to be patterned on the substrate 542. After the first region of the substrate 542 is patterned using the reticle 550, the substrate 542 may be moved, shifted or re-oriented on the stage 544 so that the unpatterned second region of the substrate 542 may be moved by the stage 544 under the reticle. In this way, the second region of the respective layer can be patterned on the substrate 542. In some processes, the portions of the substrate 542 exposed by the light passed through the reticle 550 are subsequently etched and filled with the desired metal or other material layer to be formed. In some other processes, the portions of the substrate 542 not exposed by the light passed through the reticle 550 are subsequently etched and filled with the desired metal or other material layer to be formed.

In some implementations, a first stepper operation can use a first reticle to pattern and form a first half of the aperture layer 424 onto a surface of the aperture panel 418. Subsequently, a second stepper operation can use the first or a different second reticle to pattern and form a second half of the aperture layer 424 onto the surface of the aperture panel 418. Similarly, a third stepper operation can use a third reticle to pattern and form a first half of the dark layer 480 onto a surface of the backpane 402 or a surface of the aperture panel 418. Subsequently, a fourth stepper operation can use the third or a fourth reticle to pattern and form a second half of the dark layer 408 onto the surface of the backpane 402 or the aperture panel 418. Similarly, a fifth stepper operation can use a fifth reticle to pattern and form a first half of the MEMS layer 434 onto a surface of the backpane 402 or a surface of the aperture panel 418. Subsequently, a sixth stepper operation can use the fifth or a sixth reticle to pattern and form a second half of the MEMS layer 434 onto the surface of the backpane 402 or the aperture panel 418.

In some implementation, one or more of the dark layer 408, the aperture layer 424 and the MEMS layer 434 includes two or more metal or other material layers. For example, in some implementations in which the MEMS layer 434 includes two metal layers, the second metal layer can be formed over the first metal layer after the first metal layer is formed (in such case, requiring a total of four stepper operations to form a two-layer MEMS layer 434 partitioned into two halves).

While two-step stepper processing operations have just been described for illustration, in some other display implementations, three or more stepper processing operation steps can be required or desirable. For example, the formation of one or more of the aperture layer 424, the MEMS layer 434, and the dark layer 408 can include three stepper processing operations (each for a respective third of the layer) or four stepper operations (each for a respective quarter of the layer). In some such implementations, one or both of the backpane 402 and the aperture panel 418 can be partitioned into three, four, or more regions (or “subpanels”), and each of one or more of the aperture layer 424, the MEMS layer 434, and the dark layer 408 can be formed using three, four, or more reticles, respectively.

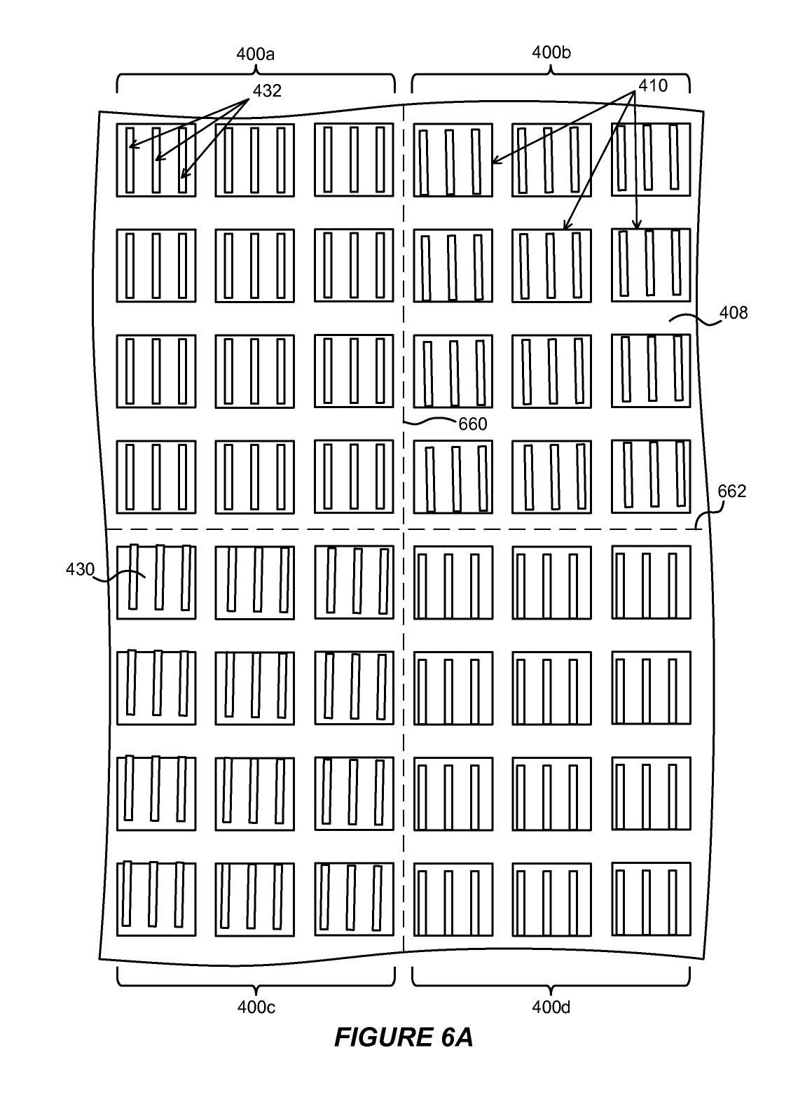

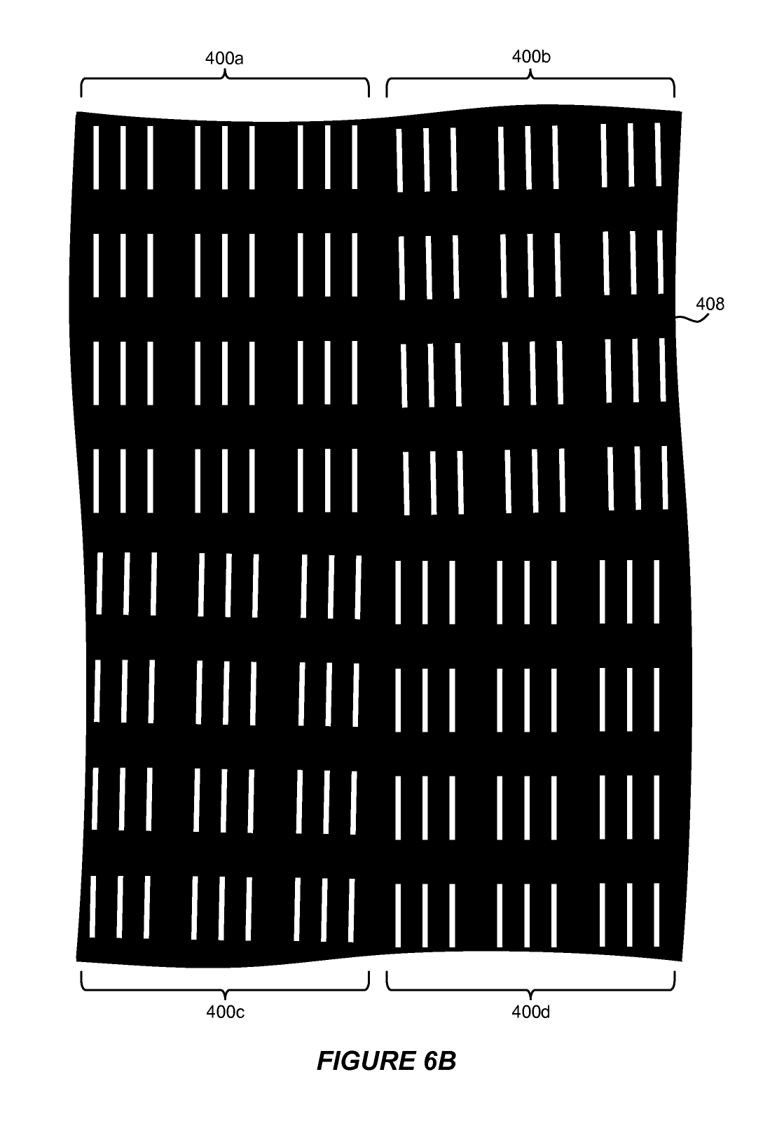

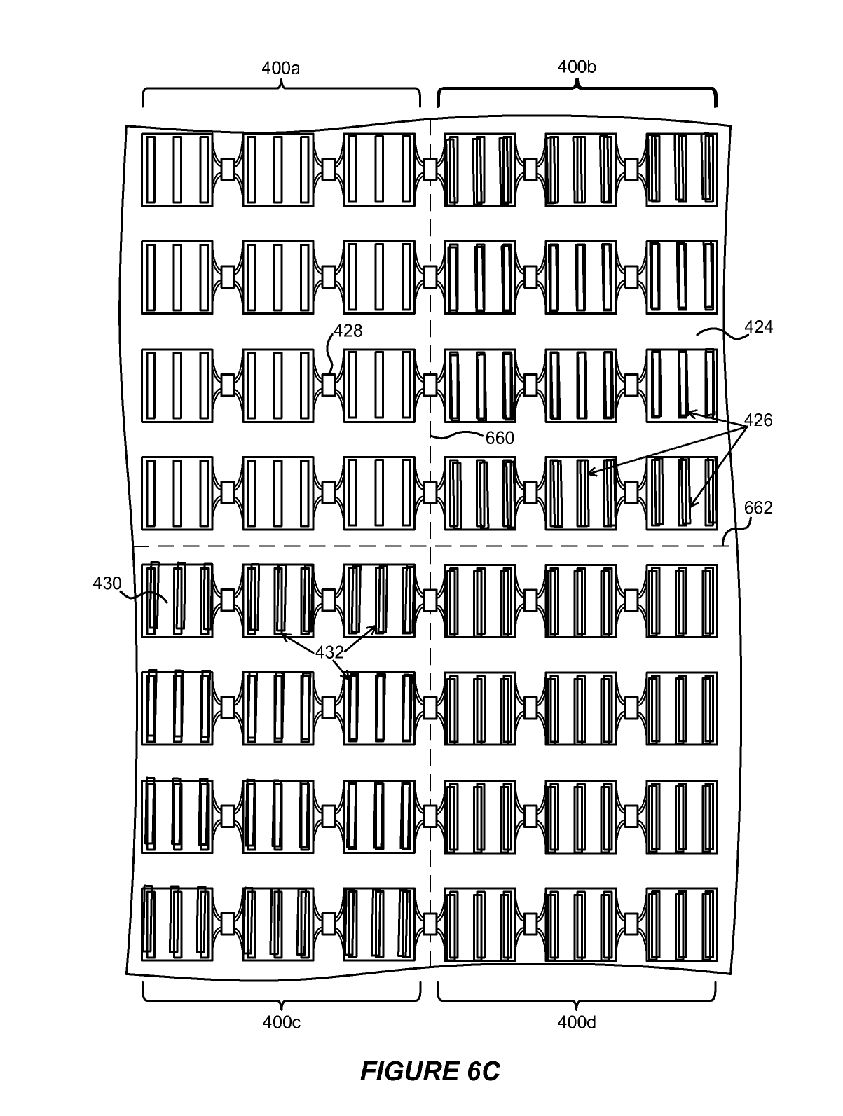

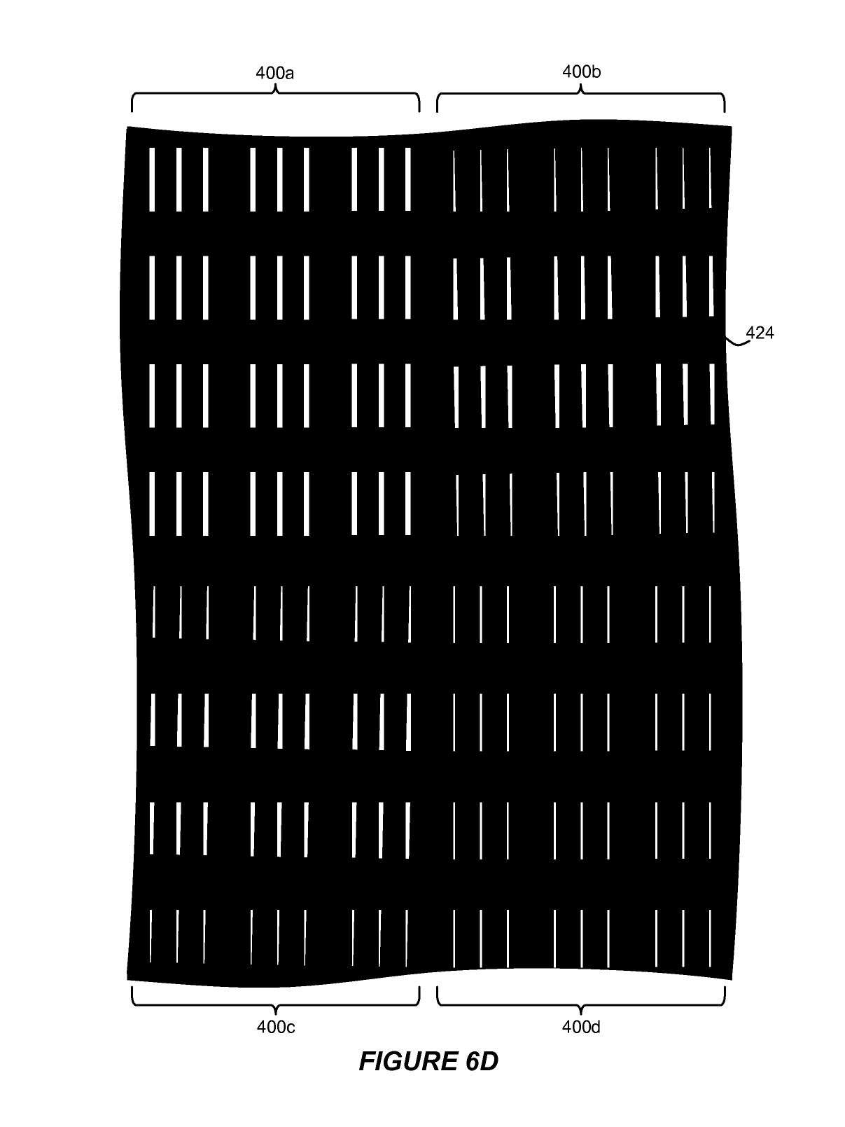

FIG. 6A shows a portion of an example dark layer 408 having rectangular apertures 410 superimposed over a portion of an example MEMS layer 434 including shutters 430 having slot-shaped apertures 432 according to some implementations. In FIG. 6A, the dark layer 408 and the shutters 430 are shown as clear to illustrate the positions of the apertures 410 relative to the apertures 432 (the actuators 428, other portions of the MEMS layer 434 and the other layers of the display panel 400 are not shown). The vertical and horizontal dotted lines 660 and 662, respectively, represent boundary or “stitch” lines indicating the intersections of four regions 400a, 400b, 400c and 400d (for example, proximate a center of a display panel which includes a region for each quadrant of the display). In the illustrated example, the layer 408 within each of the subpanels 400a, 400b, 400c and 400d can be formed using a respective stepper operation and a respective reticle. Similarly, in the illustrated example, all of the shutters 430 within each of the regions 400a, 400b, 400c and 400d can be formed using a respective stepper operation and a respective reticle.

Misalignment between any one or more of the layers within a given region can result in reduced luminosity or quality (for example, a darker, less clear or reduced quality image). For example, in region 400a, the apertures 410 in the dark layer 408 are properly aligned with the apertures 432 of the shutters 430 in the MEMS layer 434. However, in each of the other regions 400b, 400c and 400d, the apertures 410 in the dark layer 408 are misaligned with the apertures 432 of the shutters 430 in the MEMS layer 434. For example, the apertures 432 of the shutters 430 in region 400b are skewed at an angle left of 90° from the apertures 410 in the dark layer 408. The apertures 432 of the shutters 430 in region 400c are skewed at an angle right of 90° from the apertures 410 in the dark layer 408. In the region 400d, the apertures 432 of the shutters 430 are misaligned downward and leftward from the apertures 410 in the dark layer 408. FIG. 6B shows the arrangement of FIG. 6A, but in FIG. 6B the example dark layer 408 and the example shutters 430 of the MEMS layer 434 are shown in black. FIG. 6B may better illustrate how the passage of light through the respective apertures 410 and 432 can adversely be affected and even reduced by misalignment. As described below, misalignment between one or both of the dark layer 408 and the MEMS layer 434 relative to the aperture layer 424 in each of the regions can result in even more undesired restriction or obstruction of the passage of light, and as such, further adversely affect the image quality.

FIG. 6C shows an example MEMS layer 434 including shutters 430 having slot-shaped apertures 432 superimposed over an example aperture layer 424 having slot-shaped apertures 426 according to some implementations. In FIG. 6C, the MEMS layer 434 and the aperture layer 424 are shown as clear to illustrate the positions of the apertures 432 relative to the apertures 426 (the other layers of the display panel 400 including the dark layer 408 are not shown). The vertical and horizontal dotted lines 660 and 662, respectively, represent boundary stitch lines indicating the intersections of four regions 400a, 400b, 400c and 400d (for example, proximate a center of a display panel which includes a region for each quadrant of the display). In the illustrated example, the layer 434 within each of the regions 400a, 400b, 400c and 400d can be formed using a respective (one, two, or more step) stepper operation and a respective reticle (or set of reticles). Similarly, in the illustrated example, the aperture layer 424 within each of the regions 400a, 400b, 400c and 400d can be formed using a respective stepper operation and a respective reticle.

In region 400a of FIG. 6C, the apertures 426 in the aperture layer 424 are aligned with the apertures 432 in the shutters 430 of the MEMS layer 434. However, in each of the other regions 400b, 400c and 400d, the apertures 426 in the aperture layer 424 are misaligned with the apertures 432 in the shutters 430 of the MEMS layer 434. For example, the apertures 426 in the aperture layer 424 in region 400b are skewed at an angle left of 90° from the apertures 432 in the shutters 430 of the MEMS layer 434. The apertures 426 in the aperture layer 424 in region 400c are skewed at an angle right of 90° from the apertures 432 in the in shutters 430 of the MEMS layer 434. The apertures 426 in the aperture layer 424 in region 400d are misaligned downward and leftward from the apertures 432 in the shutters 430 of the MEMS layer 434. FIG. 6D shows the arrangement of FIG. 6C, but in FIG. 6D the example aperture layer 424 and the example shutters 430 and actuators 428 of the MEMS layer 434 are shown in black. FIG. 6D may better illustrate how the passage of light through the respective apertures 426 and 432 can adversely be affected and even reduced or obstructed by misalignment.

As just described, any one or more of the dark layer 408, the aperture layer 424 and the MEMS layer 434, as well as any other desired layer included in the display panel 400, can be misaligned relative to one another in a given portion or region of the overall display panel 400. Furthermore, because each of the layers within these different regions is produced by different stepper operations, the misalignment is generally not consistent from one region to the next. This can result in field boundary (or “stitch”) lines between adjacent regions that are visually perceptible to the human eye. Additionally, some regions may be more luminous (or “brighter”) than other ones of the regions resulting in a reduced quality image.

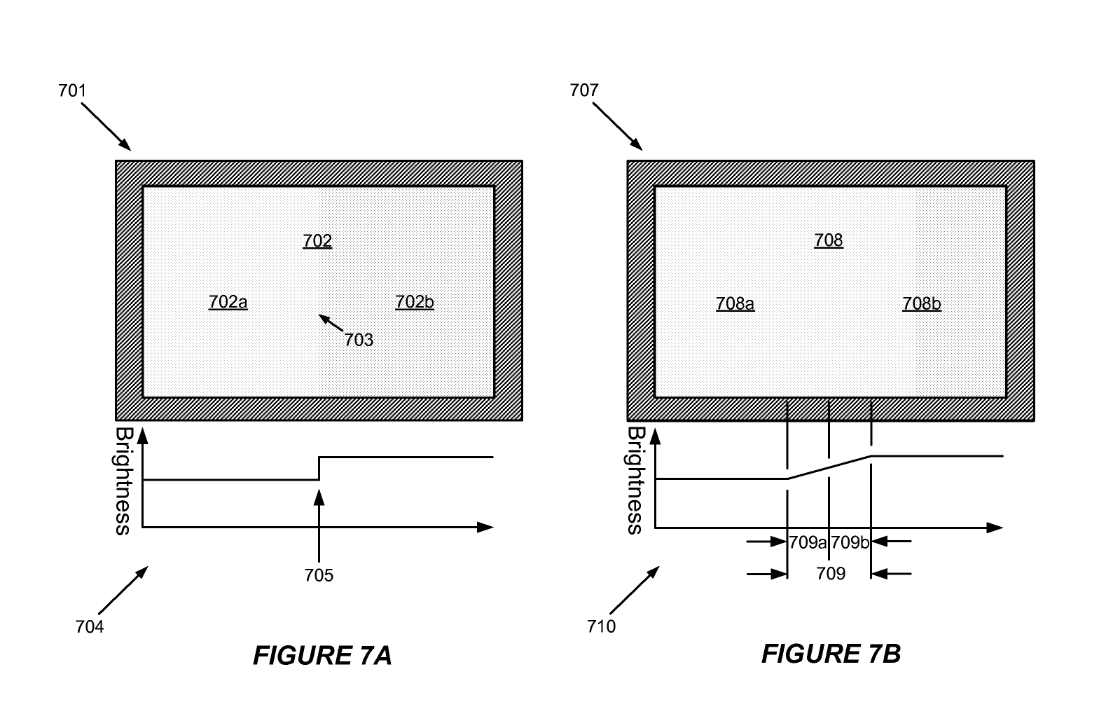

FIG. 7A shows an example display device 701 including a display panel 702 that includes two regions or subpanels 702a and 702b. The two regions 702a and 702b exhibit different luminosities as a result of different misalignments of one or more of the dark layer 408, the aperture layer 424 and the MEMS layer 434 in the two regions 702a and 702b. For example, while there may be misalignment of the respective layers in both of the regions 702a and 702b, the misalignment of the layers in the region 702a can be to a greater extent relative to the misalignment of the layers in the region 702b resulting in the appearance of a less luminous image formed by the region 702a. Also shown below the display device 701 in FIG. 7A is a plot 704 showing the luminosity or brightness of the display panel 702 as a function of position from the left side of the display panel 702 to the right side of the display panel 702. As shown in the display panel 702, a boundary stitch line 703 is perceptible at the interface where the two regions 702a and 702b meet. The stitch line 703 also is reflected in the plot 704 as an abrupt discontinuous step 705 in the brightness at the stitch line 703.

Various implementations relate to a dithering process used to introduce dither in the formation of display elements proximate region boundary lines. Various implementations also relate to display panels and constituent display elements formed using a dithering process. Dither can be broadly defined as an intentional application of noise or the result of the application of such noise, although in some implementations, the noise can be applied according to specifically designed patterns rather than randomly. The dithering processes described herein can broadly serve to mitigate the appearance of boundary lines between adjacent regions. In some implementations, various dithering processes described herein also can serve to reduce the disparities in the luminosities of the different regions. In some implementations, dither is introduced when forming each of one or more of the dark layer 408, the aperture layer 424 and the MEMS layer 434 (which may include two or more metal or other layers). In some implementations, dither is introduced using specially designed reticles, for example, during the stepper operations described above with reference to FIG. 5. In some such implementations, dither is introduced during the formation of only those display elements 412 that are located within a defined distance from a boundary line separating one respective region from an adjacent region.

FIG. 7B shows an example display device 707 including a display panel 708 that includes two regions or subpanels 708a and 708b according to some implementations. As described above, the display panel 708 can be a multi-pane display panel including two or more stacked panels or panes including, for example, the backpane 402 and the aperture panel 418 described above with reference to FIGS. 4A-4D. As also described above, the display panel 708 can include multiple patterned layers including, for example, the dark layer 408, the aperture layer 424 and the MEMS layer 434, among other layers. The two regions 708a and 708b exhibit different luminosities as a result of different misalignments of one or more of the dark layer 408, the aperture layer 424 and the MEMS layer 434 in the two regions 708a and 708b. For example, as described above with reference to FIG. 7A, while there may be misalignment of the respective layers in both of the regions 708a and 708b, the misalignment of the layers in the region 708a can be to a greater extent relative to the misalignment of the layers in the region 708b resulting in the appearance of a less luminous image formed by the region 708a. Also shown below the display device 707 in FIG. 7B is a plot 710 showing the luminosity or brightness of the display panel 708 as a function of position from the left side of the display panel 708 to the right side of the display panel 708.

The display panel 708 of FIG. 7B differs from the display panel 702 of FIG. 7A as a result of dither introduced during the formation of one or more of the dark layer 208, the aperture layer 424 and the MEMS layer 434 in each of the left and right regions 708a and 708b. More specifically, dither is introduced in a dithered region 709. The dithered region 709 includes the display elements 412 on either side of the interface between the two regions 708a and 708b. For example, a first portion (for example, a first half) 709a of the dithered region 709 includes the display elements 412 located within a defined distance from the right boundary of the left region 708a. Similarly, a second portion (for example, a second half) 709b of the dithered region 709 includes the display elements 412 located within a defined distance from the left boundary of the right region 708b. As shown in the display panel 708, there is no perceptible boundary stitch line at the interface where the two regions 708a and 708b meet as a result of the dither introduced in each of the regions 708a and 708b within the dithered region 709. Additionally, as indicated in the brightness plot 710, the brightness gradually climbs in the dithered region 709 from the lower value in the left region 708a to the upper value in the right region 708b; as opposed to the display panel 702 of FIG. 7A in which the brightness jumps abruptly from the lower value to the upper value at the interface of the two regions 702a and 702b.

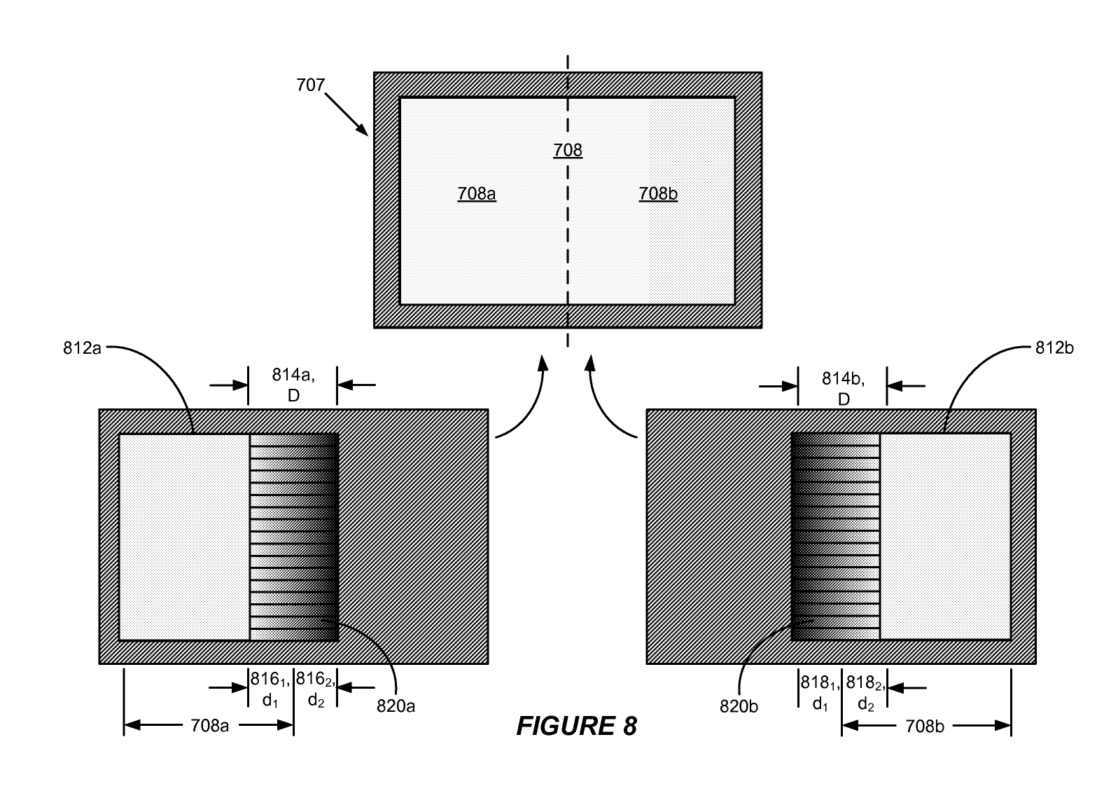

FIG. 8 shows the display panel 708 of FIG. 7B along with separated views of representations of first and second reticles used to pattern each of the regions 708a and 708b (an imaginary dotted line illustrates the boundary between the regions 708a and 708b). The first and second reticles 812a and 812b can be used in a layer patterning process for forming the dark layer 408, the aperture layer 424 or the MEMS layer 434 in the respective regions. As described above, a different reticle is used during the formation of each of the dark layer 408, the aperture layer 424 and the MEMS layer 434 (which may include two or more metal or other layers). Additional, the reticles 812a and 812b, while used to pattern the same respective layer in each of the regions 708a and 708b, can be different for the left and the right regions 708a and 708b. In some implementations, the reticle 812a for the left region 708a extends not only over the left region but also over an adjacent portion of the right region 708b (for example, corresponding to the second dithered portion 709b shown in FIG. 7B). Similarly, the reticle 812b for the right region 708b extends not only over the right region but also over an adjacent portion of the left region 708a (for example, corresponding to the first dithered portion 709a shown in FIG. 7B). More specifically, the first and the second reticles 812a and 812b include respective dithering portions 814a and 814b that overlap the other one of the regions.

The dithering portion 814a for the left reticle 812a includes a portion 816₁ that extends leftward a distance d₁ from the right boundary of the left region 708a, and a portion 816₂ that extends rightward a distance d₂ from the right boundary into the region of the right region 708b. Similarly, the dithering portion 814b for the right reticle 812b includes a portion 818₂ that extends rightward a distance d₂ from the left boundary of the right region 708b, and a portion 818₁ that extends leftward a distance d₁ from the left boundary into the region of the left region 708a. Thus, each of the dithering portions 814a and 814b extends a total width D equal to the sum of d₁ and d₂. In some implementations, the distances d₁ and d₂ are equal and the dithering portions 814a and 814b are complementary to one another across the boundary line.

Additionally, while the regions 708a and 708b are illustrated as if each is being patterned by the respective one of the reticles 812a and 812b prior to the patterning of the other one of the regions, in practice, a first one of the regions (for example, region 708a) would be patterned first by the respective reticle, and subsequently, the second one of the regions (for example, region 708b) would be patterned by the respective other reticle. In this way, the dithering portion of the reticle for the second one of the regions would pattern the desired dithered layer over the dithered layer patterned by the dithering portion of the reticle for the first one of the regions. The result of the patterning (and subsequent deposition of the actual layer based on the patterning) using both of the reticles 812a and 812b in this two-region implementation would be a complete layer over the entire panel 708 that includes the dithered region 709 formed based on the combination of the patterning by the first dithering portion 814a and the patterning by the second dithering portion 814b. More specifically, the resultant layer deposited or otherwise formed based on the patterning by the dithering portions 816₁ and 818₁ can form the dithered region 709a shown in FIG. 7B, while the resultant layer formed based on the patterning by the dithering portion 816₂ and 818₂ can form the dithered region 709b shown in FIG. 7B.

In FIG. 8, each of the dithering portions 814a and 814b include a number of dithering elements 820a and 820b, respectively. As described above, each of the dithering elements 820b of the second reticle 812b can be complementary to a corresponding dithering element 820a of the first reticle 812a. In some implementations, all of the dithering elements 820a can be identical and all of the dithering elements 820b can be identical. In some other implementations, the dithering elements 820a can be different from one another and the dithering elements 820b can be different from one another.

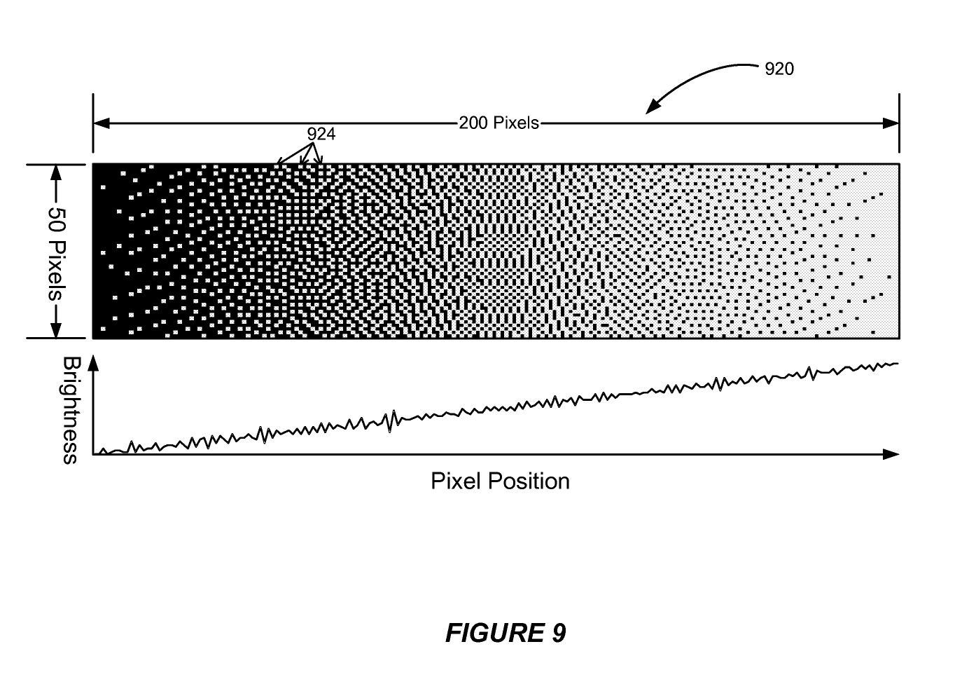

FIG. 9 shows a representation of an example dithering element 920 according to some implementations. The dithering element 920 is 200 pixels wide and 50 pixels long (for example, where each pixel 924 includes the area for one or more of the display elements 412). In some implementations, as the distance towards the bulk of the respective region increases along the width of the dithering element 920, more of the respective layer is patterned, for example, because more of the light directed at the dithering element 920 is passed. Conversely, as the distance towards the adjacent region increases along the width of the dithering element 920, less of the respective layer is patterned, for example, because less of the light directed at the dithering element 920 is passed. In some implementations, as a result, the portion of the dithering element 920 closest to the bulk of the region patterns the respective layer entirely or almost entirely, while the portion of the dithering element 920 that overlaps the adjacent region the furthest doesn't pattern or scarcely patterns the layer.

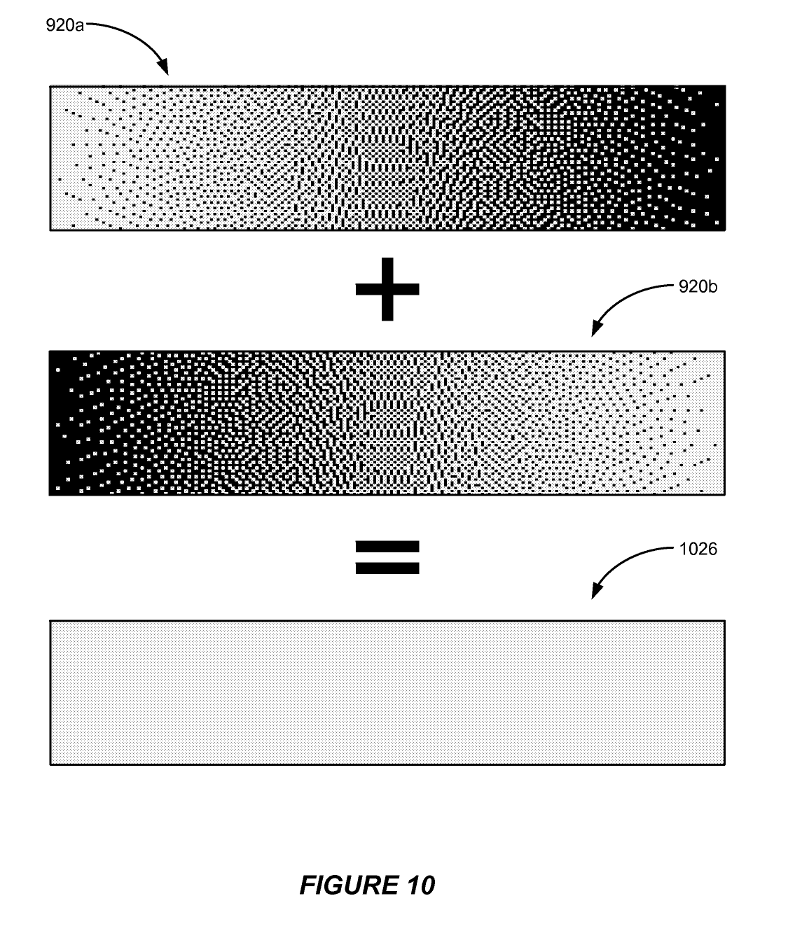

FIG. 10 shows a representation of a dithering element 920a for patterning a dithered region 1026 using a first reticle, a dithering element 920b for patterning the dithered region 1026 using a second reticle, and the resulting dithered region 1026 after patterning by both of the dithering elements 920a and 920b according to some implementations. As shown in FIG. 10, because each of the dithering elements 920a of the first reticle are complementary to a corresponding dithering element 920b of the second reticle, and because the dithering elements 920a and 920b pattern the same region 1026, the result is a complete dithered region of the respective layer (for example, a complete dark layer 408, a complete aperture layer 424, or a complete MEMS layer 434 (or complete constituent metal layer used to form a multi-layered MEMS layer 434)).

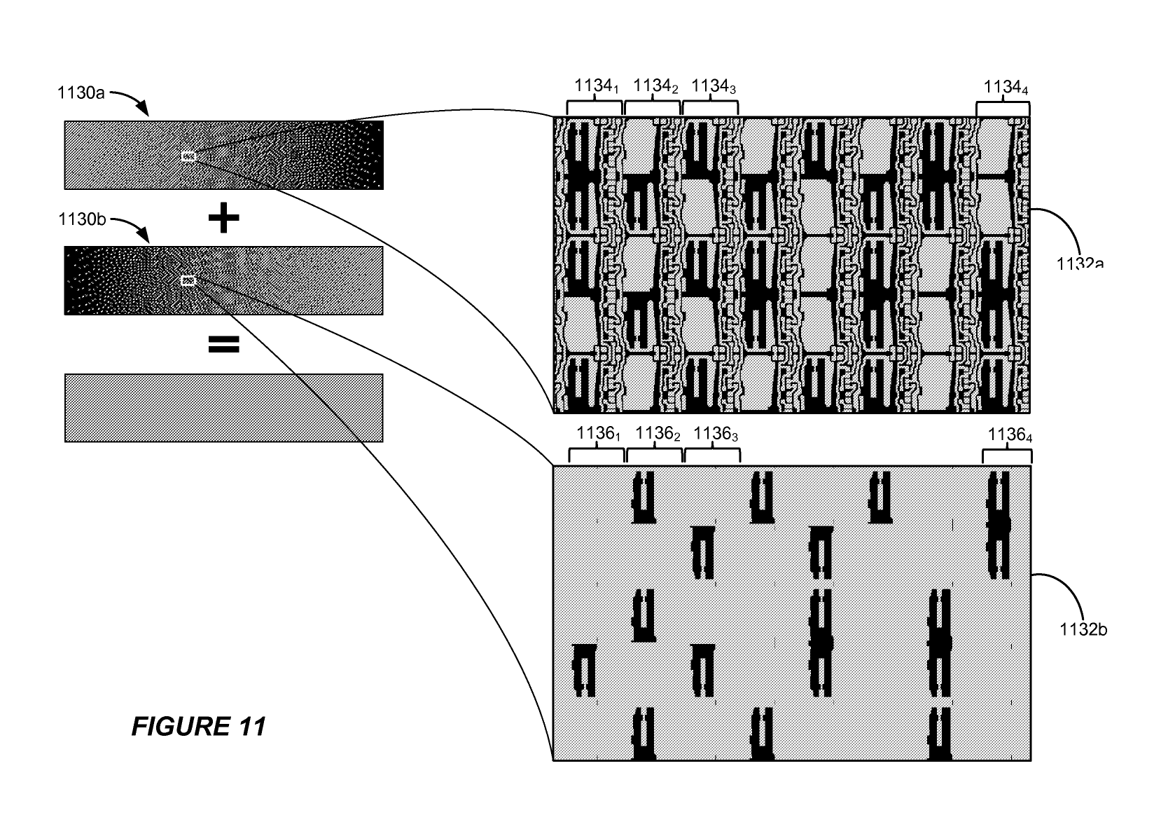

FIG. 11 shows how dithering can be used to form a dithered portion of a first metal layer of a multi-layered MEMS layer 434 according to some implementations. A first dithering element 1130a from a first reticle includes a multiplicity of pixel elements 1134, each for a respective display element 412. Element 1132a shows an expanded view of a portion of the first dithering element 1130a. A second dithering element 1130b from a second reticle includes a multiplicity of pixel elements 1136, each for a respective display element 412. Element 1132b shows an expanded view of a portion of the second dithering element 1130b.

The dithering elements 1130a and 1130b each include pixel elements of four cell types. The pixel elements 1134 and 1136 are arranged throughout the dithering elements 1130a and 1130b, respectively, according to a defined distribution or pattern, and more specifically, based on the corresponding cell types. For example, the dithering element 1130a includes pixel elements 1134₁ of a first cell type that each form a complete portion of the first metal layer for a respective display element 412. The dithering element 1130a also includes second pixel elements 1134₂ of a second cell type that each form a portion of a respective display element 412 including a wiring pattern and a first half of an aperture pattern. The dithering element 1130a also includes third pixel elements 1134₃ of a third cell type that each form a portion of a respective display element 412 including a wiring pattern and a second half of the aperture pattern. The dithering element 1130a also includes fourth pixel elements 1134₄ of a fourth cell type that each form a portion of a respective display element 412 including a wiring pattern but no aperture pattern. Complementarily, the dithering element 1130b includes pixel elements 1136₁ of a first cell type that don't result in the formation of any portion of the first metal layer for the respective display elements 412. The dithering element 1130b also includes second pixel elements 1136₂ of a second cell type that each form a portion of a respective display element 412 including a second half the aperture pattern. The dithering element 1130b also includes third pixel elements 1136₃ of a third cell type that each form a portion of a respective display element 412 including a first half of the aperture pattern. The dithering element 1130b also includes fourth pixel elements 1136₄ of a fourth cell type that each form a complete aperture pattern for a respective display element 412.

Because the dithering elements 1130a and 1130b are complementary, after the respective reticles are used to pattern the respective portions of the first metal layer on the substrate, the resultant combined superset of the portions of the first metal layer formed by the dithering elements 1130a and 1130b form a complete dithered region of the first metal layer proximate the boundary between the regions. Although there may be some misalignment of the first metal layer portions formed by the respective reticles, the noise introduced by the dithering elements 1130a and 1130b of the reticles blurs or smoothes out the field boundary lines and the appearance of the misalignment between the adjacent regions.

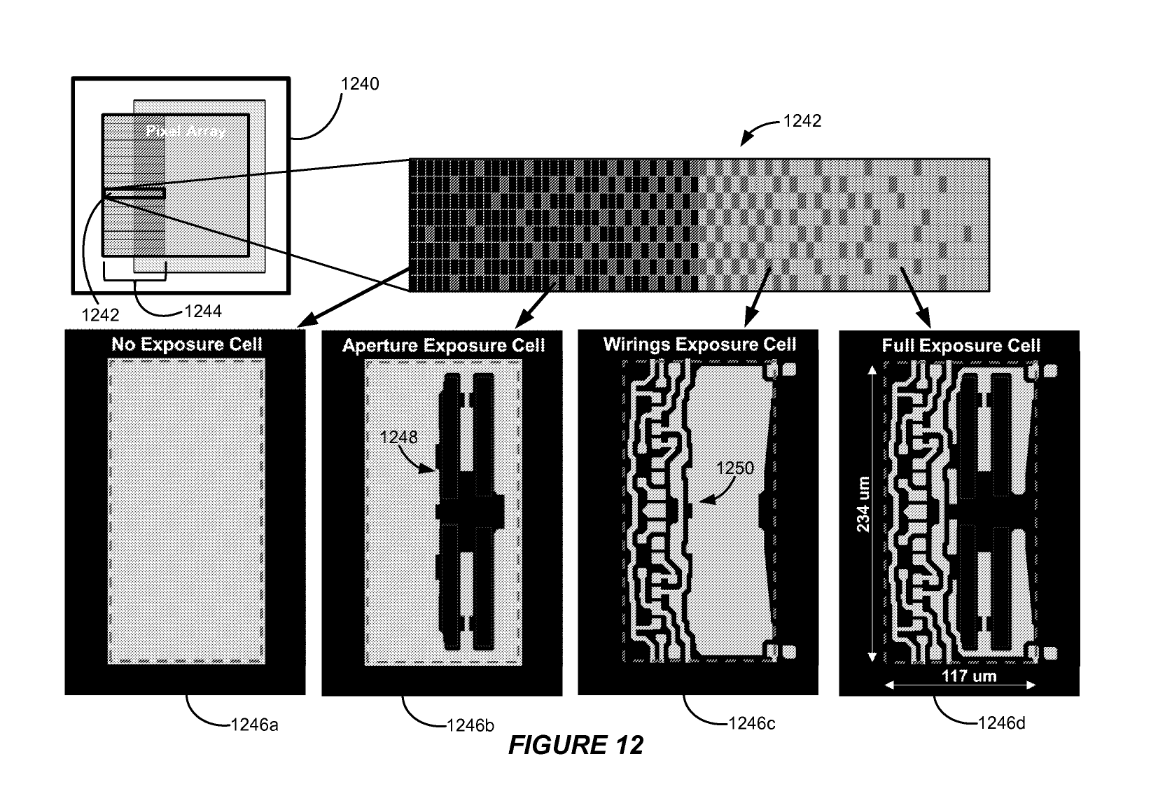

FIG. 12 shows another example of a right reticle 1240 for patterning and forming a first metal layer of a MEMS layer 434 on a right region according to some implementations. As described above, the reticle 1240 includes a dithering portion 1244 that also extends over a portion of the left region. The dithering portion 1244 includes a number of dithering elements 1242 (also shown in an expanded view next to the reticle 1240). Each dithering element 1242 includes a multiplicity of pixel elements 1246. In FIG. 12, each pixel element 1246 also is one of four cell types. The pixel elements 1246 are arranged throughout the dithering element 1242 according to a defined distribution or pattern, and more specifically, based on the corresponding cell types. The four arrows originating from the pixel elements 1246 in the dithering element 1242 each point from a corresponding pixel element 1246 to an enlarged view of the respective pixel element. For example, a first pixel element 1246a has a first cell type that results in no exposure of the adjacent surface of the substrate by the light shown on the reticle 1240. A second pixel element 1246b has a second cell type that results in the exposure and formation of an aperture pattern 1248 on the adjacent surface of the substrate. For example, the aperture pattern 1248 can form a portion of a display element 412 (for example, a portion of the MEMS layer 434). A third pixel element 1246c has a third cell type that results in the exposure and formation of a wiring pattern 1250 on the adjacent surface of the substrate. For example, the wiring pattern 1250 can form a portion of a display element 412 (for example, a second portion of the MEMS layer 434). A fourth pixel element 1246d has a fourth cell type that results in the exposure and formation of both the aperture pattern 1248 and the wiring pattern 1250 on the adjacent surface of the substrate.

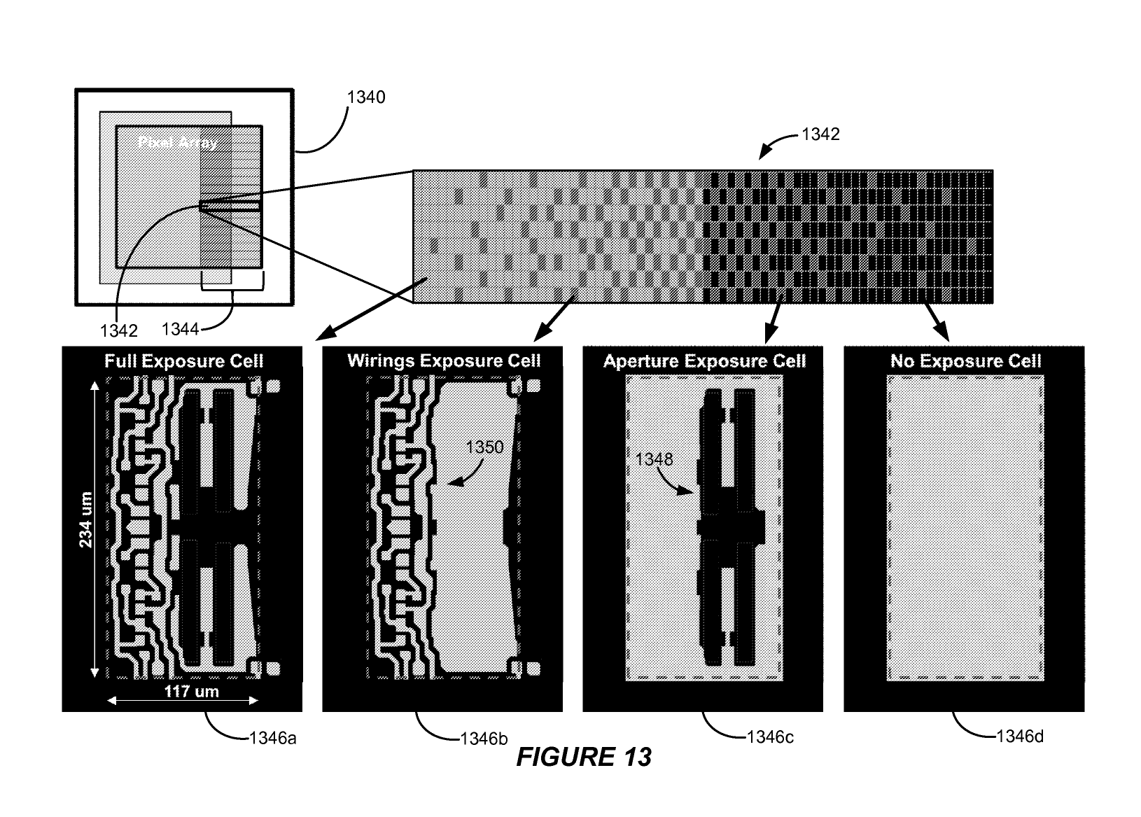

FIG. 13 shows another example of a left reticle 1340 for patterning and forming a first metal layer of a MEMS layer 434 on a left region according to some implementations. As described above, the reticle 1340 include a dithering portion 1344 that also extends over a portion of the right region. The dithering portion 1344 includes a number of dithering elements 1342 (also shown in an expanded view next to the reticle 1340). Each dithering element 1342 includes a multiplicity of pixel elements 1346. In FIG. 13, similar to FIG. 12, each pixel element 1346 also is one of four cell types. The pixel elements 1346 are arranged throughout the dithering element 1342 according to a defined distribution or pattern, and more specifically, based on the corresponding cell types. The four arrows originating from the pixel elements 1346 in the dithering element 1342 each point from a corresponding pixel element 1346 to an enlarged view of the respective pixel element. For example, a first pixel element 1346a has a first cell type that results in the exposure and formation of both an aperture pattern 1348 and a wiring pattern 1350 on the adjacent surface of the substrate. A second pixel element 1346b has a second cell type that results in the exposure and formation of only the wiring pattern 1350 on the adjacent surface of the substrate. A third pixel element 1346c has a third cell type that results in the exposure and formation of only the aperture pattern 1348 on the adjacent surface of the substrate. A fourth pixel element 1346d has a fourth cell type that results in no exposure of the adjacent surface of the substrate by the light shown on the reticle 1340.

In the illustrated implementation, the arrangement of the pixel elements 1346 of the dithering element 1342 is again complementary to the arrangement of the pixel elements 1246 of the dithering element 1242. Because of the complementary arrangements of the pixel elements 1246 and 1346, and because half of each of the dithering elements 1242 and 1342 in each of the respective reticles overlaps the adjacent region, after the left and right reticles 1242 and 1342 are used to pattern and form the desired layer in the respective regions, the portions of the layer in the dithered region proximate the border between the adjacent panels will be completed. For example, after the reticles 1240 and 1340 are used to pattern the desired layer, the pixel elements 1346a of the dithering elements 1342 are patterned over the same respective regions of the underlying substrate as the pixel elements 1246a of the dithering elements 1242. Similarly, the pixel elements 1346b are patterned over the same respective regions of the substrate as the pixel elements 1246b; the pixel elements 1346c are patterned over the same respective regions of the substrate as the pixel elements 1246c; and the pixel elements 1346d are patterned over the same respective regions of the substrate as the pixel elements 1246d. In other words, the arrangements of the pixel elements 1346 of the dithering element 1342 and the pixel elements 1246 of the dithering element 1242 are complementary such that complete portions of the desired layer are formed in the dithered region after their application.

While the dithering elements in the implementations described with reference to FIGS. 11, 12 and 13 include four cell types, in some other implementations, different patterns and cell types can be utilized. Additionally, in some other implementations, two, three or more than four cell types can be utilized in the dithering elements.

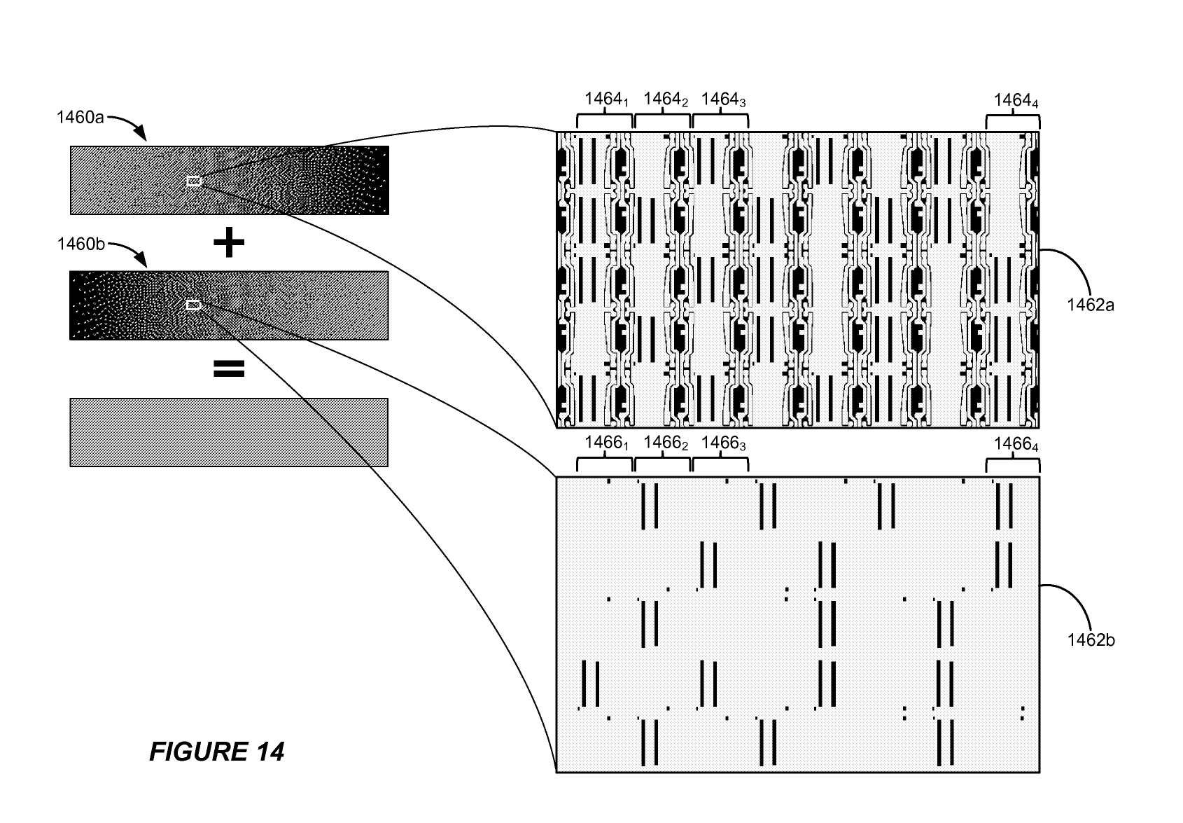

FIG. 14 shows how dithering can be used to form a dithered portion of a second metal layer of a multi-layered MEMS layer 434 according to some implementations. A first dithering element 1460a from a first reticle includes a multiplicity of pixel elements 1464, each for a respective display element 412. Element 1462a shows an expanded view of a portion of the first dithering element 1460a. A second dithering element 1460b from a second reticle includes a multiplicity of pixel elements 1466, each for a respective display element 412. Element 1462b shows an expanded view of a portion of the second dithering element 1460b.

The dithering elements 1460a and 1460b each include pixel elements of four cell types. The pixel elements 1464 and 1466 are arranged throughout the dithering elements 1460a and 1460b, respectively, according to a defined distribution or pattern, and more specifically, based on the corresponding cell types. For example, the dithering element 1460a includes pixel elements 1464₁ of a first cell type that each form a complete portion of the second metal layer for a respective display element 412. The dithering element 1460a also includes second pixel elements 1464₂ of a second cell type that each form a portion of a respective display element 412 including a wiring pattern and a first half of an aperture pattern. The dithering element 1460a also includes third pixel elements 1464₃ of a third cell type that each form a portion of a respective display element 412 including a wiring pattern and a second half of the aperture pattern. The dithering element 1460a also includes fourth pixel elements 1464₄ of a fourth cell type that each form a portion of a respective display element 412 including a wiring pattern but no aperture pattern. Complementarily, the dithering element 1460b includes pixel elements 1466₁ of a first cell type that don't result in the formation of any portion of the second metal layer for the respective display elements 412. The dithering element 1460b also includes second pixel elements 1466₂ of a second cell type that each form a portion of a respective display element 412 including a second half the aperture pattern. The dithering element 1460b also includes third pixel elements 1466₃ of a third cell type that each form a portion of a respective display element 412 including a first half of the aperture pattern. The dithering element 1460b also includes fourth pixel elements 1466₄ of a fourth cell type that each form a complete aperture pattern for a respective display element 412.

Because the dithering elements 1460a and 1460b are complementary, after the respective reticles are used to pattern the respective portions of the second metal layer on the substrate, the resultant combined superset of the portions of the second metal layer formed by the dithering elements 1460a and 1460b form a complete dithered region of the second metal layer proximate the boundary between the regions. Although there may be some misalignment of the second metal layer portions formed by the respective reticles, the noise introduced by the dithering elements 1460a and 1460b of the reticles blurs or smoothes out the field boundary lines and the appearance of the misalignment between the adjacent regions.

Additionally, because there may be some misalignment between the first metal layer and the second metal layer of the multi-layered MEMS layer 434, the noise introduced by the dithered regions formed in the first and second metal layers can work synergistically to further blur or smooth out the field boundary lines as well as to reduce luminance differences between the left region and the right region.

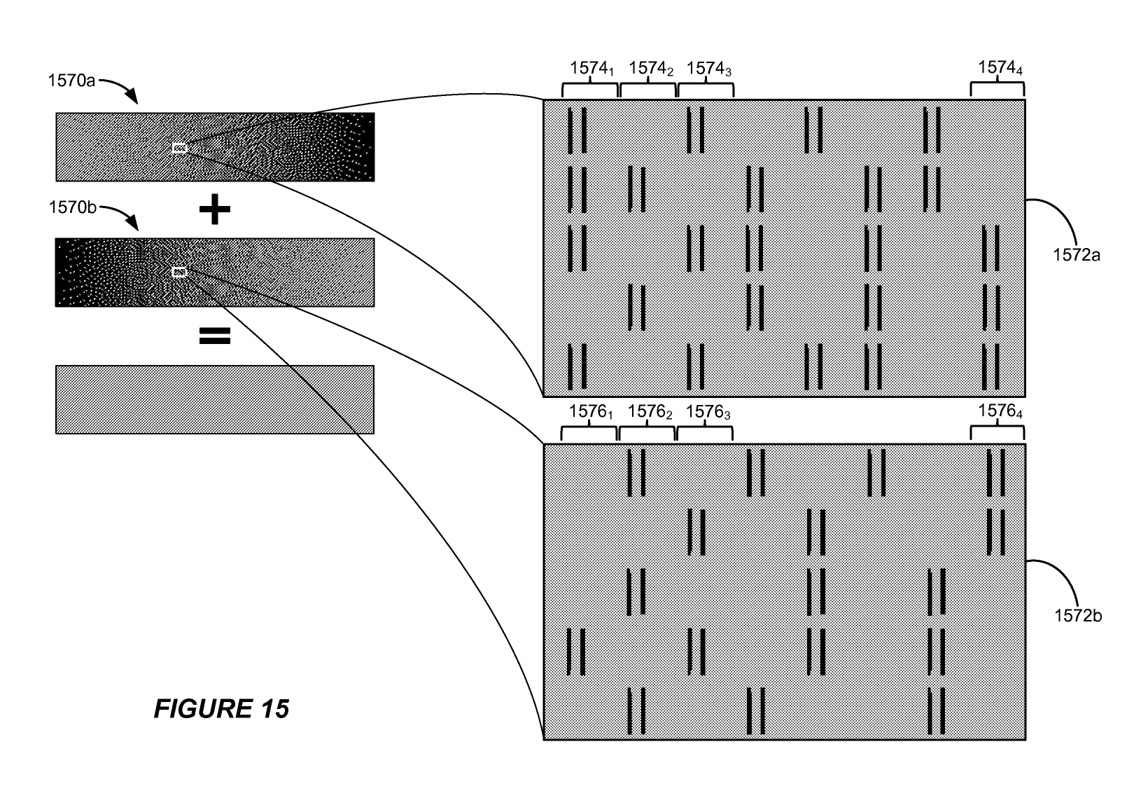

FIG. 15 shows how dithering can be used to form a dithered portion of an aperture layer 424 according to some implementations. A first dithering element 1570a from a first reticle includes a multiplicity of pixel elements 1574, each for a respective display element 412. Element 1572a shows an expanded view of a portion of the first dithering element 1570a. A second dithering element 1570b from a second reticle includes a multiplicity of pixel elements 1576, each for a respective display element 412. Element 1572b shows an expanded view of a portion of the second dithering element 1570b.

The dithering elements 1570a and 1570b each include pixel elements of four cell types. The pixel elements 1574 and 1576 are arranged throughout the dithering elements 1570a and 1570b, respectively, according to a defined distribution or pattern, and more specifically, based on the corresponding cell types. For example, the dithering element 1570a includes pixel elements 1574₁ of a first cell type that each form a complete portion of the aperture layer 424 for a respective display element 412. The dithering element 1570a also includes second pixel elements 1574₂ of a second cell type that each form a first half of the aperture layer 424 for a respective display element 412. The dithering element 1570a also includes third pixel elements 1574₃ of a third cell type that each form a second half of the aperture layer 424 for a respective display element 412. The dithering element 1570a also includes fourth pixel elements 1574₄ of a fourth cell type that don't result in the formation of any portion of the aperture layer 424 for the respective display elements 412. Complementarily, the dithering element 1570b includes pixel elements 1466₁ of a first cell type that don't result in the formation of any portion of the aperture layer 424 for the respective display elements 412. The dithering element 1570b also includes second pixel elements 1576₂ of a second cell type that each form a second half the aperture layer 424 for a respective display element 412. The dithering element 1570b also includes third pixel elements 1576₃ of a third cell type that each form a first half of the aperture layer 424 for a respective display element 412. The dithering element 1570b also includes fourth pixel elements 1576₄ of a fourth cell type that each form a complete aperture layer 424 for a respective display element 412.

Because the dithering elements 1570a and 1570b are complementary, after the respective reticles are used to pattern the respective portions of the aperture layer 424 on the substrate, the resultant combined superset of the portions of the aperture layer formed by the dithering elements 1570a and 1570b form a complete dithered region of the aperture layer proximate the boundary between the regions. Although there may be some misalignment of the aperture layer portions formed by the respective reticles, the noise introduced by the dithering elements 1570a and 1570b of the reticles blurs or smoothes out the field boundary lines and the appearance of the misalignment between the adjacent regions.

Additionally, because there may be some misalignment between the aperture layer 424 and one or both of the first metal layer and the second metal layer of the multi-layered MEMS layer 434, the noise introduced by the dithered regions formed in the aperture layer 424 and the first and second metal layers of the MEMS layer 434 can work synergistically to further blur or smooth out the field boundary lines as well as to reduce luminance differences between the left region and the right region. Indeed, the described dithering processes can similarly be used when forming the dark layer 408 or any other layer that may have an effect on the luminosity of a region. The dithering regions of all such layers can work synergistically to blur or smooth out the appearances of misalignment and differences in luminosity. For example, any of the “optical” layers of the display elements 412 can be subject to the dithering techniques described herein; for example, the dark layer 408, a gate insulating layer, an etching stop layer, a passivation layer, a third metal layer, a mold layer (for example, a layer used to form the beams described above with respect to FIGS. 2A and 2B). Additionally, other layers that can have any effect on the image formed by the display elements 412 also can be subjected to dithering, for example, an indium gallium zinc oxide (IGZO) layer, an indium tin oxide (ITO) layer, an anchor layer, and a plurality of via hole layers. Differences in these layers can cause variations in the driving voltage for the shutter or in shutter speed, which in turn can cause a variations in luminance between the left region and the right region (or between any other regions of a multi-panel display).

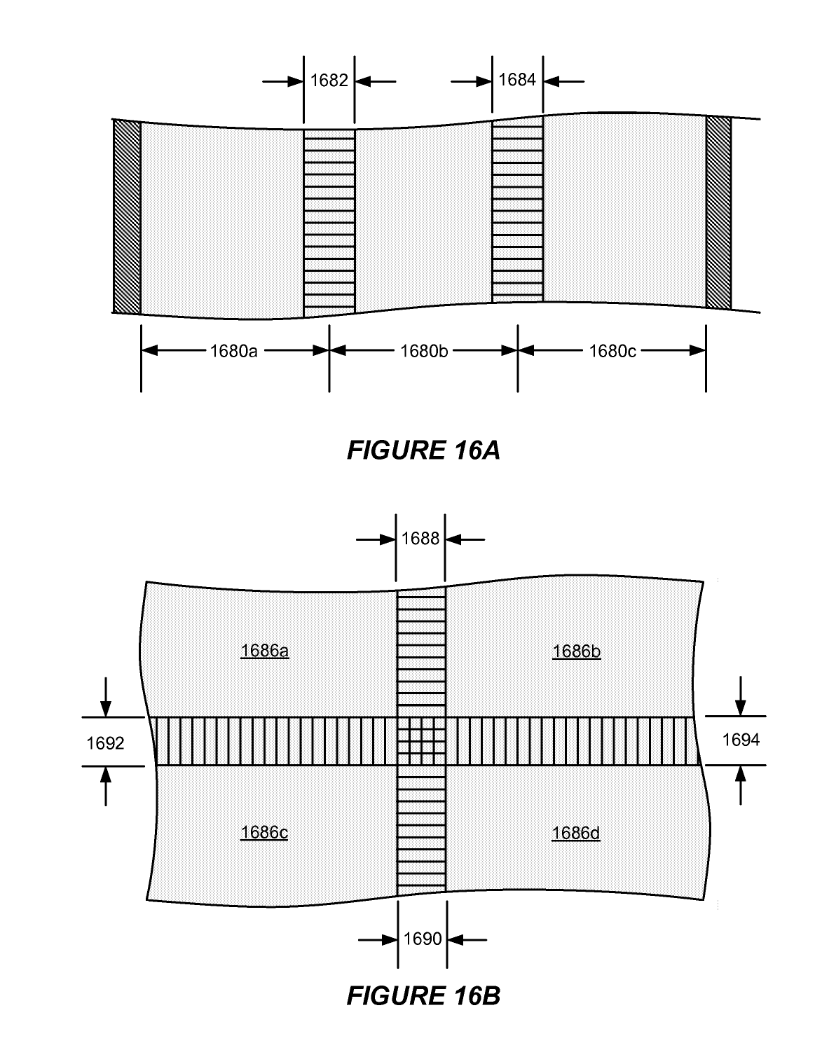

It should also be understood that the dithering processes described herein can be applied to display panels partitioned into any number or arrangement of regions. For example, a display panel having three regions arranged linearly can be formed using three reticles, where the middle reticle includes dithering portions on each of two edges of the reticle—one adjacent the leftmost region and one adjacent the rightmost region. FIG. 16A shows a portion of an example display panel that includes three regions according to some implementations. The three regions include a first (or left) region 1680a, a second (or middle) region 1680b and a third (or right) region 1680c. A first (or left) dithered region 1682 overlaps the boundary between the left and middle regions 1680a and 1680b. A second (or right) dithered region 1684 overlaps the boundary between the middle and right regions 1680b and 1680c.

In some implementations, all, substantially all, or most of the display elements (or layers thereof) proximate the left boundary of the left dithered region 1682 are patterned using the reticle(s) used to pattern the left region 1680a. Similarly, all, substantially all, or most of the display elements (or layers thereof) proximate the right boundary of the left dithered region 1682 are patterned using the reticle(s) used to pattern the middle region 1680b. Similarly, all, substantially all, or most of the display elements (or layers thereof) proximate the right boundary of the right dithered region 1684 are patterned using the reticle(s) used to pattern the right region 1680c. Similarly, all, substantially all, or most of the display elements (or layers thereof) proximate the left boundary of the right dithered region 1684 are patterned using the reticle(s) used to pattern the middle region 1680b.

However, at the boundary between the left and middle regions 1680a and 1680b, respectively, approximately half of the display elements (or portions or layers thereof) are patterned using the reticle(s) for the left region 1680a and approximately half of the display elements (or portions or layers thereof) are patterned using the reticle(s) for the middle region 1680b. Similarly, at the boundary between the middle and right regions 1680b and 1680c, respectively, approximately half of the display elements (or portions or layers thereof) are patterned using the reticle(s) for the middle region 1680b and approximately half of the display elements (or portions or layers thereof) are patterned using the reticle(s) for the right region 1680c.

Similarly, a display panel having four regions arranged as in FIGS. 6A-6D can be formed using four reticles, each of which includes dithering portions on two inner edges of the respective reticle. FIG. 16B shows a portion of an example display panel that includes four regions according to some implementations. The four regions include a first (or upper-left) region 1686a, a second (or upper-right) region 1686b, a third (or lower-left) region 1686c, and a fourth (or lower-right) region 1686d. A first dithered region 1688 overlaps the boundary between the first and second regions 1686a and 1686b. A second dithered region 1690 overlaps the boundary between the third and fourth regions 1686c and 1686d. A third dithered region 1692 overlaps the boundary between the first and third regions 1686a and 1686c. A fourth dithered region 1694 overlaps the boundary between the second and fourth regions 1686b and 1686d. In some such implementations, some display elements (or portions or layers thereof) proximate the center of the display panel where the four regions meet can be patterned using the reticle(s) for two, three or all four of the regions 1686a-1686d.

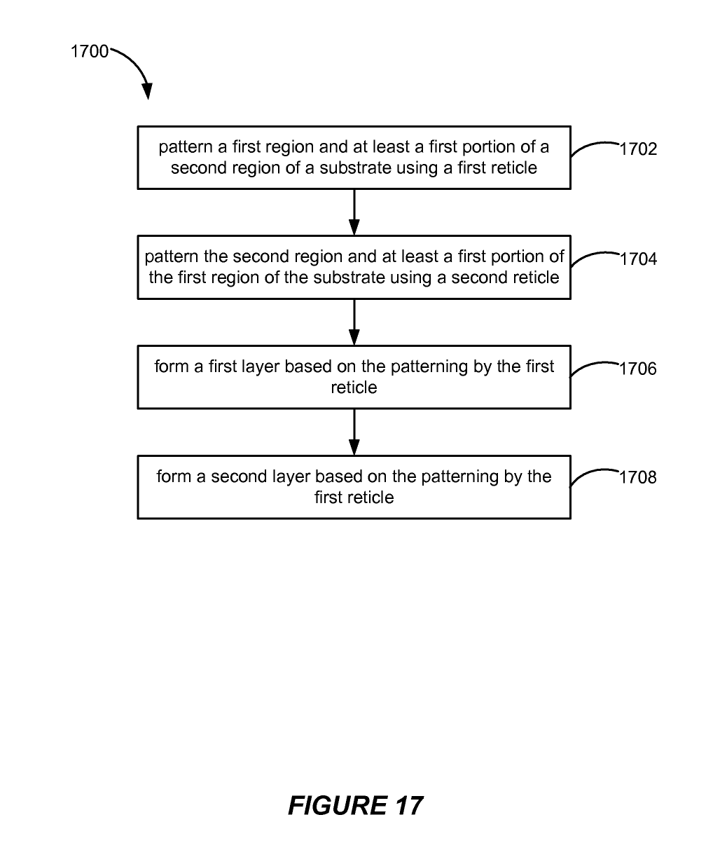

FIG. 17 shows a flowchart illustrating an example process 1700 for forming a dithered region on a substrate. In some implementations, the process 1700 begins in block 1702 with patterning a first region and at least a first portion of a second region of the substrate using a first reticle. For example, the patterning can be performed by a stepper processing machine such as that described with reference to FIG. 5. In some implementations, the substrate can be the backpane 402 or the aperture panel 418 described above. The process 1700 also includes patterning, in block 1704, the second region and at least a first portion of the first region of the substrate using a second reticle. The process 1700 continues in block 1706 with forming a first layer based on the patterning by the first reticle, the first layer including an array of patterned elements. The process 1700 continues in block 1708 with forming a second layer based on the patterning by the second reticle, the second layer including an array of patterned elements. In some implementations, the first and the second layer can collectively form any one of the dark layer 408, the aperture layer 424, or a layer of a multilayer MEMS layer 434. In some implementations, to form the first and the second layers, the portions of the first and second regions of the substrate exposed by the light passed through the first and the second reticles are subsequently etched and filled with the desired metal or other material layer to be formed. In some other implementations, the first and second regions of the substrate not exposed by the light passed through the first and second reticles are subsequently etched and filled with the desired metal or other material layer to be formed.

As described above, the array of patterned elements of the first layer on the first portions can be incomplete. For example, the array of patterned elements of the first layer on the first portions form part of a dithered region as described above. The array of patterned elements of the second layer on the first portions also can be incomplete. For example, the array of patterned elements of the second layer on the first portions also form part of the dithered region as described above. As described above, the array of patterned elements of the first layer on the first portions can be complementary to the array of patterned elements of the second layer on the first portions such that the patterned elements of the first and second layers on the first portions are complete, forming a dithered region.

Various dithering element designs can be suitable for introducing dither as described herein. Some example dithering design patterns include a Bayer distribution of the various types of dithering cells (for example, the arrangement of the “full exposure” cells and the “no exposure” cells as well as in some implementations, the arrangement of one or more types of partial exposure cells). Other possible dithering designs utilize a Halftone distribution, a Screw distribution, an Emphatic Gray distribution, a random distribution, as well as a Floyd-Steinberg error diffusion distribution, and a Blue noise mask-based distribution, or other suitable distributions. Additionally, as described above, in some implementations the size of each cell in each dithering element corresponds to the size of one display element. In some other implementations, a given cell can correspond to two or more display elements; for example, two or more adjacent display elements within one row or within one column (or four or more adjacent display elements in two adjacent rows and two adjacent columns).

FIGS. 18A and 18B show system block diagrams of an example display device 40 that includes a plurality of display elements. For example, the display elements can be MEMS-based display elements such as the shutter-based display elements described above. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 18A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology, or further implementations thereof. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

Some or all of the electrical voltages or electrical currents described herein can be considered electrical signals, regardless of whether such signals are provided, applied, detected, sensed, measured or determined, and regardless of whether such signals are static or time-varying signals. Some signals described herein are binary signals capable of having one of two possible states. For example, such binary signals can have a first (or high) value and a second (or low) value. However, no limitation is inherent or suggested by way of referring to a signal as high or low. On the contrary, such high and low labels are intended to facilitate the description of the disclosed implementations, and not to define an operating range of the associated signal. Additionally, such high and low labels as described in the context of one type of transistor (for example, an n-type transistor) can be reversed in the context of a second type of transistor (for example, a p-type transistor). The signals described herein can be carried, provided or received via corresponding signal lines. The term “line” also is used interchangeably herein with interconnect, trace, wire and link, where appropriate.

As used herein, the conjunction “or” is intended herein in the inclusive sense where appropriate unless otherwise indicated; that is, the phrase “A, B or C” is intended to include the possibilities of A, B, C, A and B, B and C, A and C and A, B and C. Additionally, a phrase referring to “at least one of” a list of items refers to any combination of those items, including single members. As an example, “at least one of: A, B, or C” is intended to cover: A, B, C, A-B, A-C, B-C, and A-B-C.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Some designs for implementing dithering elements can be produced in software. Some dithering processes can be implementing using software. In either case, if implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A device comprising:
a substrate including a first region and a second region, a boundary of the first region proximate a boundary of the second region;
a first layer over the substrate, the first layer being patterned in the first region and in a first portion of the second region with a first array of first patterned elements;
the first layer being further patterned in the second region and in a first portion of the first region with a second array of second patterned elements;
each of the first and the second arrays being incomplete in each of the first portions;
the first array of first patterned elements in the first portion of the second region being complementary to the second array of second patterned elements in the first portion of the second region;
the first array of first patterned elements in the first portion of the first region being complementary to the second array of second patterned elements in the first portion of the first region;
the combination of the first array of first patterned elements and the second array of second patterned elements in the first portions of the first and the second regions forming a complete array of patterned elements.

2. The device of claim 1, wherein:
the first array of first patterned elements includes cells of a first pattern type and a second pattern type;
the second array of second patterned elements includes cells of a first pattern type and a second pattern type;
the first array cells of the first pattern type are complementary to the second array cells of the first pattern type; and
the first array cells of the second pattern type are complementary to the second array cells of the second pattern type.

3. The device of claim 2, wherein:
the first array cells of the first pattern type include no patterned elements;
the first array cells of the second pattern type include complete patterned elements;
the second array cells of the first pattern type include complete patterned elements; and
the second array cells of the second pattern type include no patterned elements;

4. The device of claim 2, wherein:
each first array cell of the first pattern type includes a first portion of the patterned elements;
each first array cell of the second pattern type includes a second portion of the patterned elements;
each second array cell of the first pattern type includes the second portion of the patterned elements; and
each second array cell of the second pattern type includes the first portion of the patterned elements.

5. The device of claim 2, wherein:
the first array of first patterned elements further includes cells of a third pattern type and cells of a fourth pattern type;
the second array of second patterned elements further includes cells of a third pattern type and cells of a fourth pattern type;
the first array cells of the third pattern type are complementary to the second array cells of the third pattern type;
the first array cells of the fourth pattern type are complementary to the second array cells of the fourth pattern type;
each first array cell of the third pattern type includes a third portion of the patterned elements;
each first array cell of the fourth pattern type includes a fourth portion of the patterned elements;
each second array cell of the third pattern type includes the fourth portion of the patterned elements; and
each second array cell of the fourth pattern type includes the third portion of the patterned elements.

6. The device of claim 1, further including:
a second layer over the substrate, the second layer being patterned in the first region and in the first portion of the second region with a third array of third patterned elements;
the second layer being further patterned in the second region and in the first portion of the first region with a fourth array of fourth patterned elements;
each of the third and the fourth arrays being incomplete in the first portions of the first and the second regions; and
the third array of third patterned elements in the first portion of the second region being complementary to the fourth array of fourth patterned elements in the first portion of the second region;
the third array of third patterned elements in the first portion of the first region being complementary to the fourth array of fourth patterned elements in the first portion of the first region;
the combination of the third array of third patterned elements and the fourth array of fourth patterned elements in the first portions of the first and the second regions forming a complete second array of patterned elements.

7. The device of claim 1, further including:
a second substrate including a third region and a fourth region, a boundary of the third region proximate a boundary of the fourth region;
a second layer over the second substrate, the second layer being patterned in the third region and in a first portion of the fourth region with a third array of third patterned elements;
the second layer being further patterned in the fourth region and in a first portion of the third region with a fourth array of fourth patterned elements;
each of the third and the fourth arrays being incomplete in the first portions of the third and the fourth regions;
the third array of third patterned elements in the first portion of the fourth region being complementary to the fourth array of fourth patterned elements in the first portion of the fourth region;
the third array of third patterned elements in the first portion of the third region being complementary to the fourth array of fourth patterned elements in the first portion of the third region;
the combination of the third array of third patterned elements and the fourth array of fourth patterned elements in the first portions of the third and the fourth regions forming a complete array of patterned elements.

8. The device of claim 1, wherein:
the substrate is a panel of a display that includes an array of display elements; and
the combination of the first array of first patterned elements and the second array of second patterned elements form at least portions of the display elements.

9. The device of claim 8, further comprising:
a processor capable of processing image data; and
a memory device capable of communicating with the processor.

10. The device of claim 9, further comprising:
a driver circuit capable of sending at least one signal to the display elements; and
a controller capable of sending at least a portion of the image data to the driver circuit.

11. The device of claim 9, further comprising an image source module capable of sending the image data to the processor, wherein the image source module includes at least one of a receiver, transceiver, and transmitter.

12. The device of claim 9, further comprising an input device capable of receiving input data and communicating the input data to the processor.

13. A method comprising:
patterning a first region and a first portion of a second region of a substrate using a first reticle, a boundary of the first region proximate a boundary of the second region;
patterning the second region and a first portion of the first region of the substrate using a second reticle;
forming a first array of first patterned elements based on the patterning by the first reticle; and
forming a second array of second patterned elements based on the patterning by the second reticle;
each of the first and the second arrays being incomplete in each of the first portions;
the first array of first patterned elements in the first portion of the second region being complementary to the second array of second patterned elements in the first portion of the second region;
the first array of first patterned elements in the first portion of the first region being complementary to the second array of second patterned elements in the first portion of the first region;
the combination of the first array of first patterned elements and the second array of second patterned elements in the first portions of the first and the second regions forming a complete array of patterned elements.

14. The method of claim 13, wherein:
the substrate is a panel of a display that includes an array of display elements; and
the combination of the first array of first patterned elements and the second array of second patterned elements form at least portions of the display elements.

15. The method of claim 13, wherein:
the first array of first patterned elements includes cells of a first pattern type and a second pattern type;
the second array of second patterned elements includes cells of a first pattern type and a second pattern type;
the first array cells of the first pattern type are complementary to the second array cells of the first pattern type; and
the first array cells of the second pattern type are complementary to the second array cells of the second pattern type.

16. The method of claim 15, wherein:
the first array cells of the first pattern type include no patterned elements;
the first array cells of the second pattern type include complete patterned elements;
the second array cells of the first pattern type include complete patterned elements; and
the second array cells of the second pattern type include no patterned elements;

17. The method of claim 15, wherein:
each first array cell of the first pattern type includes a first portion of the patterned elements;
each first array cell of the second pattern type includes a second portion of the patterned elements;
each second array cell of the first pattern type includes the second portion of the patterned elements; and
each second array cell of the second pattern type includes the first portion of the patterned elements.

18. The method of claim 15, wherein:
the first array of first patterned elements further includes cells of a third pattern type and cells of a fourth pattern type;
the second array of second patterned elements further includes cells of a third pattern type and cells of a fourth pattern type;
the first array cells of the third pattern type are complementary to the second array cells of the third pattern type; and
the first array cells of the fourth pattern type are complementary to the second array cells of the fourth pattern type;
each first array cell of the third pattern type includes a third portion of the patterned elements;
each first array cell of the fourth pattern type includes a fourth portion of the patterned elements;
each second array cell of the third pattern type includes the fourth portion of the patterned elements; and
each second array cell of the fourth pattern type includes the third portion of the patterned elements.

19. The method of claim 13, further including:
patterning the first region and the first portion of the second region of the substrate using a third reticle;
patterning the second region and the first portion of the first region of the substrate using a fourth reticle;
forming a third array of third patterned elements based on the patterning by the third reticle; and
forming a fourth array of fourth patterned elements based on the patterning by the fourth reticle;
each of the third and the fourth arrays being incomplete in the first portions of the first and the second regions;
the third array of third patterned elements in the first portion of the second region being complementary to the fourth array of fourth patterned elements in the first portion of the second region;
the third array of third patterned elements in the first portion of the first region being complementary to the fourth array of fourth patterned elements in the first portion of the first region;
the combination of the third array of third patterned elements and the fourth array of fourth patterned elements in the first portions of the first and the second regions forming a complete second array of patterned elements.

20. The method of claim 13, further including:
patterning a third region and a first portion of a fourth region of a second substrate using a third reticle, a boundary of the third region proximate a boundary of the fourth region;
patterning the fourth region and a first portion of the third region of the second substrate using a fourth reticle;
forming a third array of third patterned elements based on the patterning by the third reticle; and
forming a fourth array of fourth patterned elements based on the patterning by the fourth reticle;
each of the third and the fourth arrays being incomplete in the first portions of the third and the fourth regions;
the third array of third patterned elements in the first portion of the fourth region being complementary to the fourth array of fourth patterned elements in the first portion of the fourth region;
the third array of third patterned elements in the first portion of the third region being complementary to the fourth array of fourth patterned elements in the first portion of the third region;
the combination of the third array of third patterned elements and the fourth array of fourth patterned elements in the first portions of the third and the fourth regions forming a complete array of patterned elements.
